(19) United States
(12) Patent Application Publication
(10) Pub. No.: US 2024/0377420 A1
(43) Pub. Date: Nov. 14, 2024

(54) SYSTEMS, DEVICES, AND METHODS FOR AUTOMATED ANALYSIS OF FLUID SAMPLES FROM A CELL PROCESSING SYSTEM

(71) Applicant: Cellares Corporation, South San Francisco, CA (US)

(72) Inventor: John CESAREK, Redwood City, CA (US)

(21) Appl. No.: 18/638,658

(22) Filed: Apr. 17, 2024

Related U.S. Application Data
(60) Provisional application No. 63/465,129, filed on May 9, 2023.

(51) Int. Cl. G01N 35/00

(52) U.S. Cl. CPC G01N 35/00613; G01N 35/00732; G01N 35/0092; G01N 35/0099; G01N 2035/00752

(57) ABSTRACT

The present disclosure relates to systems, devices, and methods for automated analysis of fluid samples from a cell processing system. In an embodiment, the system comprises a fluid device docking station configured to receive a fluid device having a fluid sample therein, a master well plate, a sample well plate, a fluid transfer system configured to transfer the fluid sample from the fluid device to the master well plate, and transfer at least a portion of the fluid sample from the master well plate to the sample well plate, an analytical instrument configured to perform an assay on the fluid sample within the sample well plate, and a robot configured to move the sample well plate to the analytical instrument.

### CROSS REFERENCE TO RELATED APPLICATIONS

This application claims priority to U.S. Provisional Patent Application No. 63/465,129, filed May 9, 2023, the contents of which are hereby incorporated in their entirety by this reference.

### TECHNICAL FIELD

The present disclosure relates to automated analysis of fluid samples from a cell processing system.

### BACKGROUND

Cell therapy, where cells from an individual patient are collected, processed ex vivo, and then returned to the same patient, has been revolutionary for producing durable and effective clinical responses in patients. However appealing, cell therapy manufacturing is a complex, often labor-intensive process that is difficult to “scale-up” and is prone to human error and contamination. While recent efforts have been made toward automating manufacturing of cell therapies, such as automating movements of cells between manufacturing steps, numerous inefficiencies remain in traditional cell therapy manufacturing. For example, quality control testing, such as in-process and release testing, of cell therapy manufacturing samples continues to require time-intensive, and often manually performed, assays for analysis and report generation, acting as a bottleneck between cell therapy manufacturing and providing cell products to patients.

Given the importance of quality control in producing an efficacious cell product additional systems, devices, and methods for quality control during cell processing are desirable. In particular, an automated system for analysis of cell therapy products is desirable to meet high patient sample throughput demands.

### SUMMARY

The present disclosure relates generally to systems, devices, and methods for automated analysis of fluid samples from a cell processing system. In general, a system herein may include a fluid device docking station configured to receive a fluid device having a fluid sample therein, a master well plate, a sample well plate, a fluid transfer system, an analytical instrument, and a robot configured to move the sample well plate to the analytical instrument. The fluid transfer system may be configured to transfer the fluid sample from the fluid device to the master well plate, and transfer at least a portion of the fluid sample from the master well plate to the sample well plate. The analytical instrument may be configured to perform an assay on the fluid sample within the sample well plate. In some variations, the analytical instrument may include one or more of a flow cytometer, a cell counter, a quantitative thermocycler, a fluorimeter, a flow-based bead reader, digital polymerase chain reaction, cell analyzers, and a microplate reader, or various combinations thereof. In some variations, the fluid device includes a fluid selected from the group consisting of assay controls, assay reagents, and fluid samples.

Another system for automated analysis of fluid samples may include a fluid device docking station configured to receive a fluid device having a fluid sample therein, a fluid device disassembly instrument configured to remove a first portion of the fluid device to expose a second portion of the fluid device, and an analytical instrument configured to perform an assay on a fluid sample retrieved from the second portion of the fluid device. In some variations, the fluid device disassembly instrument may include a transfer stage configured to receive the fluid device thereon. The transfer stage may include one or more locks to retain the fluid device thereon. Each of the one or more locks may include a locking pin configured to be received within a recess of a container of the fluid transfer device. Further, the transfer stage may include one or more sensors to detect the fluid device. Each of the one or more sensors may be a proximity sensor. In some variations, the first portion of the fluid device may be a collar, and the second portion of the fluid device may be a container. The container may be configured to hold a volume of fluid of about 10 mL. In some variations, the fluid device disassembly instrument may include a disassembly actuator configured to couple to and retain the first portion of the fluid device therein. The disassembly actuator may be further configured to release the first portion of the fluid device after the second portion of the fluid device is transferred away from the disassembly actuator. In some variations, the system may further include a waste container, and the fluid device disassembly instrument may be configured to transfer the first portion of the fluid device to the waste container. In some variations, the system may further include a device transfer system configured to transfer the fluid device to the fluid device disassembly instrument. The device transfer system may include a conveyor feedthrough. In some variations, the system may further include a fluid transfer system configured to transfer the fluid sample from a container of the second portion of the fluid device to one or more well plates. The one or more well plates may include a master well plate and a sample well plate, and the fluid transfer system may transfer at least a portion of the fluid sample from the master well plate to a sample well plate. In some variations, the system may further include a robot configured to move at least one of the one or more well plates to the analytical instrument.

Another system for automated analysis of fluid samples may include an enclosure having one or more access points configured to provide access to an interior zone of the enclosure, a fluid device docking station within the enclosure, where fluid device docking station may be configured to receive a fluid device having a fluid sample therein, a fluid device disassembly instrument within the enclosure, where the fluid device disassembly instrument may be configured to disassemble the fluid device, a first analytical instrument within the enclosure, where the analytical instrument may be configured to perform an assay on a fluid sample retrieved from the disassembled fluid device, and a cart configured to support a second analytical instrument thereon and to be transferred between the interior zone of the enclosure and an external environment. In some variations, the cart may include an instrument support surface configured to carry the second analytical instrument thereon. The instrument support surface may include a turntable configured to rotate about 180 degrees. Additionally, the instrument support surface may be a first instrument support surface of a plurality of instrument support surfaces of the cart. A second instrument support surface of the plurality of instrument support surfaces may be configured to carry a third analytical instrument thereon. The second instrument support surface may be located under the first instrument support surface. Further, the second instrument support surface may have a greater surface area than the first instrument support surface. In some variations, the cart may include a base having one or more of utility connection hub, a power supply module, and an integrated computer. The utility connection hub may include one or more of a power port, a gas port, and a network hookup port configured to couple with a corresponding utility port within the enclosure. The power supply module may be configured to provide power to one or both of the second analytical instrument and the integrated computer. In some variations, the cart may include a shock absorbing system having one or more shock absorbers coupled to one or more wheels of the cart. In some variations, the cart may be a first cart of a plurality of carts configured to be stored within the enclosure.

A method for automated analysis of fluid samples from a cell processing system is also disclosed herein. In some variations, the method may include receiving a fluid device within a fluid device docking station, the fluid device comprising a fluid sample therein, transferring, by a first fluid transfer device, the fluid sample from the fluid device to a master well plate, transferring, by a second fluid transfer device, at least a portion of the fluid sample from the master well plate to a sample well plate, and moving, by a robot, the sample well plate to an analytical instrument.

A method for automated analysis of fluid samples is also disclosed herein. In some variations, the method may include generating an assay order based on a number of fluid devices to be analyzed, each of the fluid devices containing a fluid sample corresponding to a cell therapy product within a cell processing system, updating, based on a user input, grouping information for each of the fluid devices within the assay order, the grouping information including a priority indicator for the fluid devices and for an assay, orchestrating a workflow of a quality control (QC) system based on the updated assay order and a cell processing workflow of the cell therapy product, the fluid devices initially being within the cell processing system, receiving, based on the orchestration, a fluid device within a corresponding fluid device docking station of the QC system, confirming an identity of the fluid device within the corresponding fluid device docking station, transferring, based on the orchestration, fluid sample from the identified fluid device to a master well plate within the QC system, transferring, based on the orchestration, fluid from the master well plate to at least one sample well plate within the QC system, moving the at least one sample well plate to a corresponding analytical instrument within the QC system to perform an assay on the fluid sample therein, determining, based on an assay output, whether the fluid sample satisfies one or more acceptance criterion for the assay, and releasing the cell therapy product when it is determined that the fluid sample satisfies the one or more acceptance criterion. In some variations, the orchestrating includes scheduling of cell processes related to the fluid devices. In some variations, the orchestrating includes defining one or more acceptance criterion for each fluid sample. In some variations, the orchestrating includes mapping the fluid samples to wells of each of the master well plate and the at least one sample well plate. In some variations, the orchestrating includes managing assay reagents and assay controls. In some variations, the orchestrating includes scheduling an assay start time for each assay within the assay order. In some variations, the method may include generating an assay order, orchestrating a workflow of a quality control (QC) system based on the generated assay order and a cell processing workflow of the fluid devices within a cell processing system, receiving, based on the orchestration, a fluid device from the cell processing system and within a corresponding fluid device docking station of the QC system, transferring, based on the orchestration, fluid sample from the fluid device to a master well plate within the QC system, transferring, based on the orchestration, at least a portion of the fluid sample from the master well plate to a sample well plate within the QC system, moving the sample well plate to a corresponding analytical instrument within the QC system to perform an assay on the fluid sample therein, determining, based on an output of the assay, whether the fluid sample satisfies one or more acceptance criterion, and releasing a fluid associated with the fluid sample when it is determined that the fluid sample satisfies the one or more acceptance criterion. In some variations, the assay order is generated based on a number of fluid devices to be analyzed, each of the fluid devices containing a fluid sample and grouping information for each of the fluid devices, the grouping information including a priority indicator for each of the fluid devices.

Another method for automated analysis of fluid samples may include receiving a fluid device within a fluid device docking station, where the fluid device may include a fluid sample therein, transferring the fluid device to a fluid device disassembly instrument, removing a first portion of the fluid device from a second portion of the fluid device via the fluid device disassembly instrument, and transferring at least a portion of the fluid sample from the second portion of the fluid device to an analytical instrument.

Additional variations, features, and advantages of the invention will be apparent from the following detailed description and through practice of the invention.

### BRIEF DESCRIPTION OF THE DRAWINGS

FIG. 1A is a perspective view of an illustrative variation of a workcell and cartridge of a cell processing system. FIG. 1B is a block diagram of an illustrative variation of a cell processing system.

FIG. 2 is a schematic diagram of an illustrative variation of a quality control system.

FIG. 3A is a schematic diagram of an illustrative variation of a quality control system. FIG. 3B is a schematic diagram of an illustrative variation of a quality control system, wherein components are relatively arranged within a quality control workflow. FIG. 3C is a schematic diagram of an illustrative variation of a fluid device docking station of a quality control system.

FIG. 3D is a schematic diagram of an illustrative variation of a fluid device disassembly instrument of a quality control system.

FIG. 4 is an illustrative flow diagram demonstrating a relationship between a quality control system and a cell processing system.

FIG. 5A is a flow diagram of an illustrative method of automated analysis of fluid samples within a quality control system. FIG. 5B is a flow diagram of an aspect of an illustrative method of automated analysis of fluid samples within a quality control system.

FIG. 6 is a flow diagram of an illustrative method of automated analysis of fluid samples within a quality control system.

FIG. 7 is a flow diagram of an aspect of an illustrative method of automated analysis of fluid samples within a quality control system.

FIG. 8A is a flow diagram of an illustrative method of automated analysis of fluid samples within a quality control system. FIG. 8B is a flow diagram of an illustrative method of automated analysis of fluid samples within a quality control system.

FIG. 9A is a flow diagram of an orchestration aspect of an illustrative method of automated analysis of fluid samples within a quality control system. FIG. 9B is a schematic diagram of an illustrative data management infrastructure of a quality control system for automated analysis of fluid samples.

FIG. 10 is a flow diagram of an illustrative method of analysis of fluid samples, wherein a portion of the method is performed by a quality control system.

FIG. 11A is a rendering of a perspective view of an illustrative variation of a fluid device in a closed configuration for use with a quality control system. FIG. 11B is a rendering of a perspective view of the fluid device of FIG. 11A in an open configuration.

FIGS. 12A and 12B are each a perspective view of an illustrative variation of a quality control system. FIGS. 12C-12F show four side views of the quality control system of FIGS. 12A and 12B. FIGS. 12G and 12H show a top view and a bottom view, respectively, of the quality control system of FIGS. 12A-12F.

FIG. 13A is a perspective view of an illustrative variation of a fluid device disassembly instrument. FIG. 13B is a perspective view of an illustrative variation of a transfer stage of the fluid device disassembly instrument of FIG. 13A. FIG. 13C is a perspective view of an illustrative variation of a disassembled fluid device on the fluid device disassembly instrument of FIG. 13A.

FIG. 14A is a top view of an illustrative variation of an arrangement of a device transfer system, fluid device disassembly instrument, and fluid transfer system within a quality control system. FIG. 14B is a perspective view of the arrangement of the device transfer system, fluid device disassembly instrument, and fluid transfer system of FIG. 14A.

FIG. 15A is a perspective view of an illustrative variation of a cart for use with the quality control systems herein. FIG. 15B is a perspective transparent view of an illustrative variation of a base of the cart of FIG. 15A.

FIG. 16 is a flow diagram of another aspect of an illustrative method of automated analysis of fluid samples within a quality control system.

FIG. 17 shows an arrangement of analytical and operational instruments within an exemplary quality control system.

FIG. 18 shows an exemplary process of disassembling a fluid device using a fluid device disassembling instrument.

### DETAILED DESCRIPTION

One limiting factor to the broad deployment of cell therapy manufacturing (i.e., cell processing) is the ability to perform in-process and release testing of cell therapy products because these tests require time-intensive quality control assays for analysis and report generation. Thus, high patient sample throughput demands may be met using an automated quality control system to manage the transfer, organization, and testing of cell therapy products.

The quality control (QC) systems of the present disclosure may automate in-process and release testing, facilitating cell product analyses for maximum patient impact. In some variations, the QC systems herein may be integrated with cell processing systems to produce ten times more cell products per year than conventional cell processing systems (with the same facility and workforce size). For example, the automated QC systems may help reduce turnaround time for results. In some variations, as samples (e.g., cell product-associated fluid samples) are generated by a cell processing system (described below), generating QC data quickly (e.g., in real-time) may be important to ensure that the associated cell products being generated by the cell processing system are safe for use and may be packaged and shipped for administration to a patient in quickly (e.g., days). Additionally, the QC systems may provide data quality that is comparable to, and often better than, data quality of manual processes. In some variations, the automated QC system may be configured to generate (e.g., automatically generate) electronic records for each cell product that undergoes analysis within the system. As another example, the automated QC systems may increase throughput of a cell processing system. In some variations, the automated QC systems may help meet throughput demands by performing real-time QC testing on samples (e.g., cell therapy product-associated fluid samples) as they are generated by the cell processing system. To meet increased throughput demand, a single automated QC system, as described herein, may process fluid samples from multiple cell processing systems operating concurrently. Further, the QC system may be configured to analyze a plurality of fluid samples in parallel, further increasing the throughput the cell processing system(s). In some variations, the automated QC system may help minimize staffing challenges. Specifically, the automated QC system may be configured to reduce or eliminate manual steps for performing in-process and release testing, thereby reducing the staffing burden by up to 90% (e.g., up to 70%, up to 75%, up to 80%, up to 85%, up to 90%, up to 95%, up to 100%). Additionally, the automated QC system may include backup instrumentation (e.g., for sample analysis) to provide redundancy in case one or more instruments of the system require maintenance or replacement. In general, the automated QC system may be configured to enclose all instrumentation (including backup instrumentation) therein such that a sterile environment is maintained during analysis of one or more samples (e.g., fluid samples).

Accordingly, the present disclosure provides improved systems, devices, and methods for performing automated quality control testing within a QC system to reduce the time between cell therapy product manufacturing and patient administration thereof.

### I. Cell Processing System

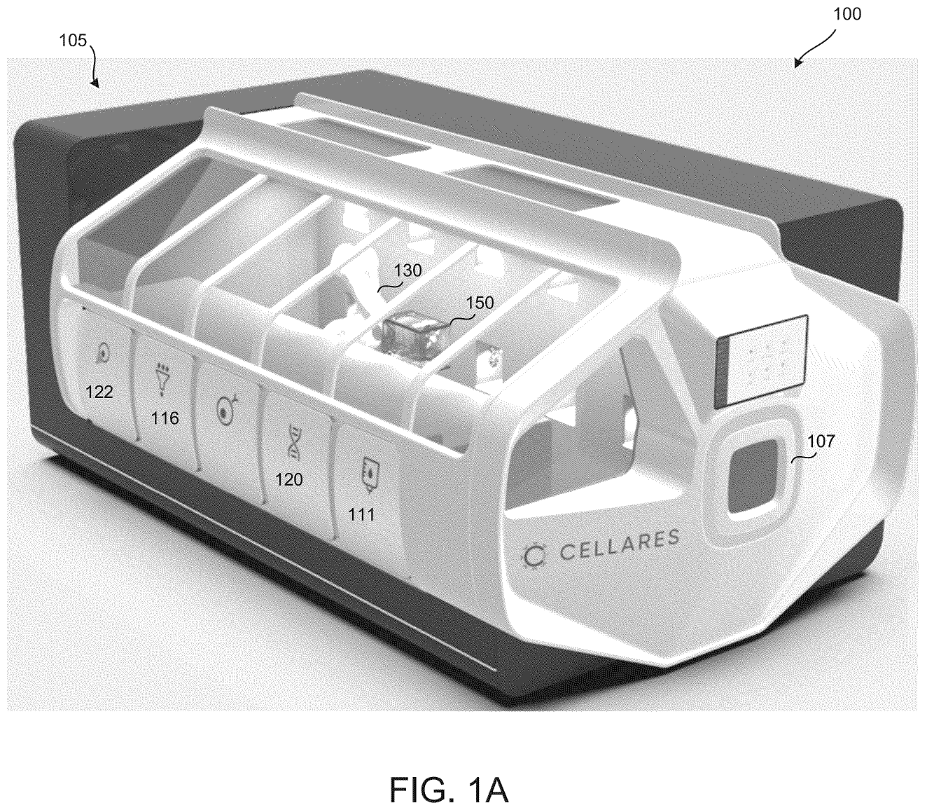

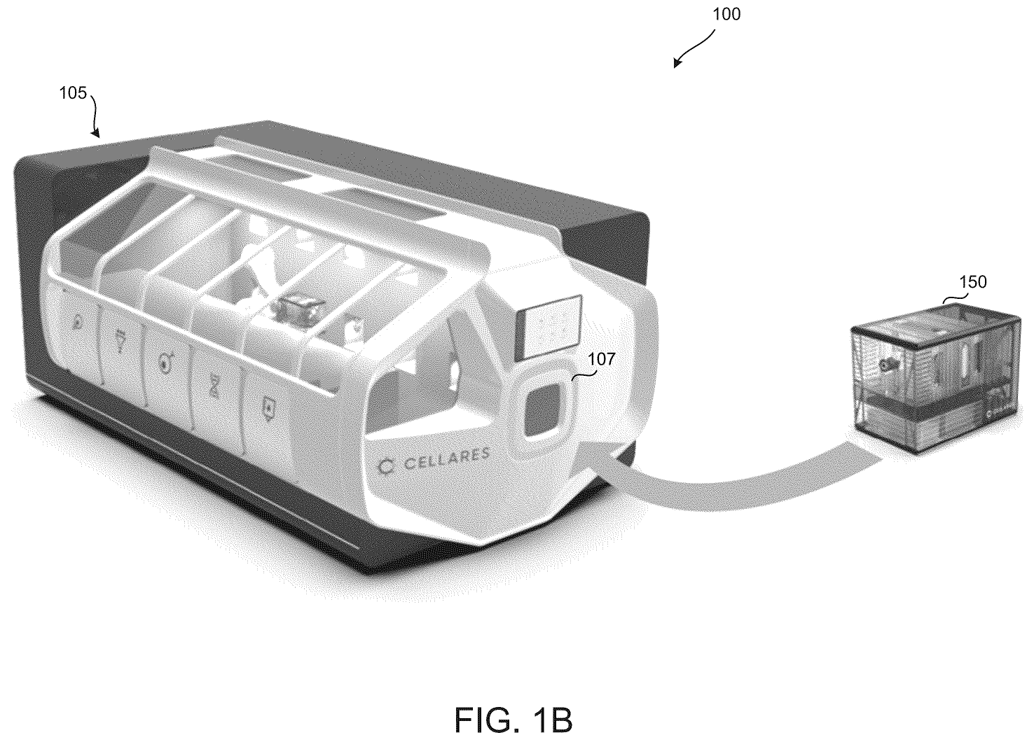

The systems, devices, and methods herein for performing automated quality control testing within a QC system may be used with a cell therapy manufacturing system, or cell processing system 100, exemplary illustrations of which are shown in FIG. 1A and FIG. 1B. As shown in FIG. 1A, cell processing may involve moving a cartridge 150 containing a cell therapy product between a plurality of instruments, such as instruments 111, 116, 120, 122, inside a workcell 105. The cartridge 150 may be received into the workcell 105 via a feedthrough 107. FIG. 1B is a perspective view of a cell processing system 100 depicting a cartridge 150 introduced into a workcell 105. A plurality of cartridges may be inserted into the workcell 105 and undergo one or more cell processing operations in parallel.

Referring again to FIG. 1A, one or more of the instruments may be configured to interface with the cartridge 150 to perform cell processing steps on cells within the cartridge 150. In some variations, a plurality of cell processing steps may be performed within the cartridge 150. For example, a robotic arm 130 may be configured to move the cartridge 150 between instruments, each instrument configured to perform a different cell processing step when coupled to a corresponding module within the cartridge 150. In some variations, the cartridge 150 may comprise any number of modules, such as a bioreactor module, a counterflow centrifugal elutriation (CCE) module, a magnetic cell sorter module, an electroporation module, a sorting module (e.g., fluorescence activated cell sorting (FACS) module), an acoustic flow cell module, a microfluidic enrichment module, and/or combinations thereof, and the like. In some variations, the workcell 105 may process two or more cartridges in parallel. For example, the workcell 105 may comprise a plurality of instruments having receiving bays, such as a bioreactor instrument 111, a cell selection instrument 116, an electroporation instrument 120, and/or a sterile liquid transfer instrument 122. Each instrument may be configured to interface with a cartridge, such as cartridge 150, received within a respective receiving bay, such that multiple instruments within the workcell 105 may be in use at any given time.

Any suitable cell processing may be performed using the systems and devices described herein, and may include steps such as growing, enriching, selecting, sorting, expanding, activating, transducing, electroporating, washing, and the like. In some variations, a method of processing a solution containing a cell product includes the steps of digesting tissue using an enzyme reagent to release a select cell population into solution, enriching cells using a CCE instrument, washing cells using the CCE instrument, selecting cells in the solution using a selection instrument, sorting cells in the solution using a sorting instrument, differentiating or expanding the cells in a bioreactor, activating cells using an activating reagent, electroporating cells, transducing cells using a vector, and finishing a cell product.

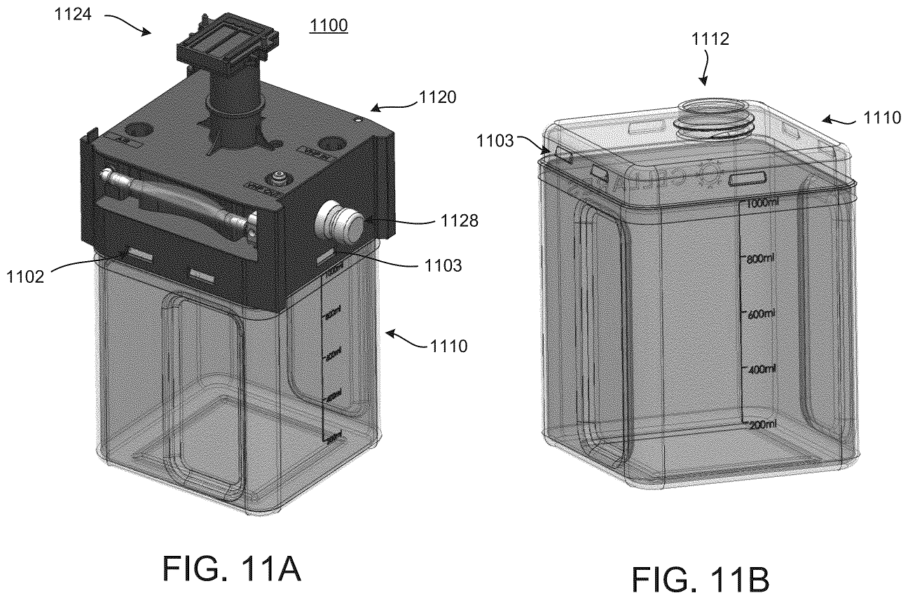

As is described herein throughout, an automated QC system of the present disclosure may be configured to process (e.g., analyze) cell therapy product-associated fluid samples from one or more cell processing systems 100. The fluid samples may be obtained from the one or more cell processing systems 100 via fluid devices. For example, fluid samples associated with a particular cell therapy product (e.g., generated within one or more corresponding cartridges 150) may be transferred to and stored within the automated QC system via a fluid device(s). The fluid devices herein may be configured to store fluid for automated transfer to components of the cell processing systems 100, such as from the workcell 105 to the QC system. Generally, the fluid devices herein may enable the transfer of fluids in an automated, sterile, and metered manner during cell processing. Illustrative fluid devices are described in more detail below with reference to FIGS. 11A and 11B.

In some variations, and prior to transfer from the cell processing system 100 to the automated QC system, fluid samples, e.g., extracted in-process samples, may be stored within fluid devices within a reagent vault of the cell processing system 100. To this end, a cartridge 150 may be moved by the robot 130 (or manually by an operator) to the reagent vault. The reagent vault may interface with one or more sterile liquid transfer ports on the cartridge 150, and a reagent, material, or fluid sample within the cartridge 150 may be transferred from the cartridge 150 to a fluid device within the reagent vault. In some variations, at least one of the plurality of instruments of the workcell 105 is a sterile liquid transfer instrument configured to transfer fluid out of the cartridge 150 and into a fluid device in an automated manner. In some variations, the robot 130 moves a fluid device(s) from the reagent vault to the sterile liquid transfer instrument. The reagent vault may have automated doors to permit access by the robot to a fluid device(s) stored therein. The fluid device(s) may be configured for pick-and-place movement by the robot 130. In some variations, the reagent vault may comprise one or more sample pickup areas. For example, the robot 130 may be configured to move one or more fluid devices 142 comprising reagents to and from one or more of the sample pickup areas. In some variations, at least one of the one or more sample pickup areas are accessible by a user from outside the cell processing system 100. In this way, fluid samples may easily be extracted from a cartridge 150, transferred to a fluid device, and made available to a user for manual transport to an automated QC system for automated, high-throughput in-process and release testing.

Additional details and other suitable cell processing systems and aspects thereof, such as the cartridge, the robot, a sterile liquid transfer instrument, and the fluid devices are provided e.g., in U.S. patent application Ser. No. 17/198,134, entitled “Systems and Methods for Cell Processing”, U.S. patent application Ser. No. 18/620,826, entitled “Systems, Devices, and Methods for Fluid Transfer Within an Automated Cell Processing System”, U.S. Provisional Patent Application No. 63/470,381, entitled “Systems, Devices, and Methods for Reagent storage in Automated Cell Processing”, U.S. Provisional Patent Application No. 63/524,596, entitled “Systems, Devices, and Methods for Fluid Transfer Within an Automated Cell Processing System”, the contents of each which are incorporated by reference herein.

### II. Automated Quality Control

### A. SYSTEMS

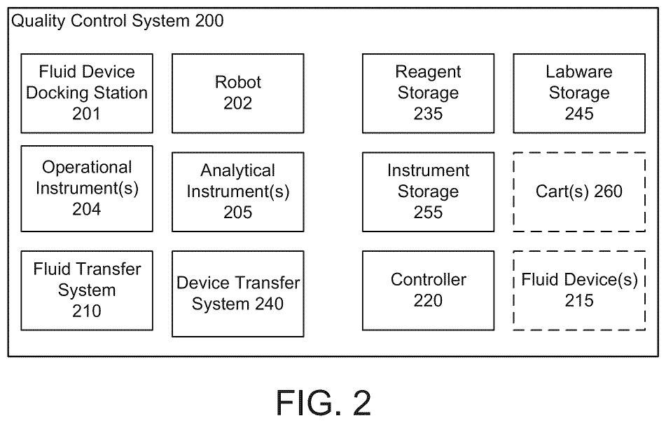

The automated quality control (QC) systems herein may be integrated with the cell processing systems herein (e.g., cell processing system 100 of FIGS. 1A-1B). A QC system may be configured to perform and output analyses of samples from cell products within a cell processing system. For example, a QC system may perform an assay on a fluid sample from a cell product being processed. In some variations, the QC systems herein may be configured to process a plurality of samples in parallel, such as 2, 3, 4, 5, 6, 7, 8, 9, 10, or more than 10 samples concurrently. Additionally, or alternatively, the QC systems herein may be configured to receive a plurality of samples to process from different cell processing systems. Further, as is described in detail below, the QC systems herein (e.g., the instruments thereof) may be modified throughout cell processing to perform a particular workflow for each of a plurality of samples. An illustrative schematic of an automated QC system 200 for use as described herein throughout is provided in FIG. 2. Generally, the QC system 200 herein may include a fluid device docking station 201, a robot 202, operational instrument(s) 204, analytical instruments(s) 205, a fluid transfer system 210, a device transfer system 240, a controller 220, a fluid device 315, a reagent storage compartment (or reagent vault) 235, a labware storage compartment 245, and instrument storage area 255, and cart(s) 260. Additionally, in some variations, the QC system 200 may include an enclosure configured to house (temporarily or permanently) some or all of the aforementioned features.

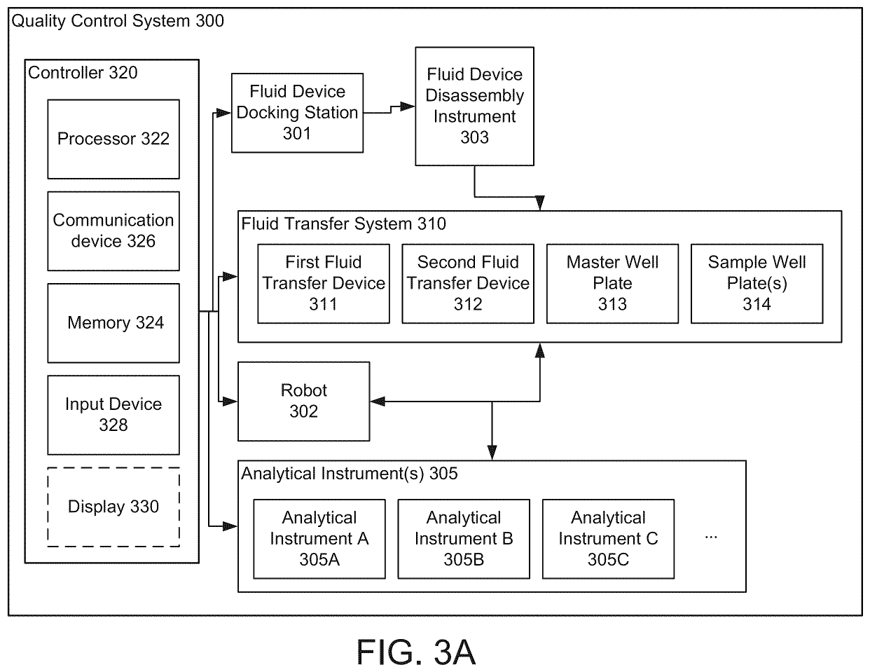

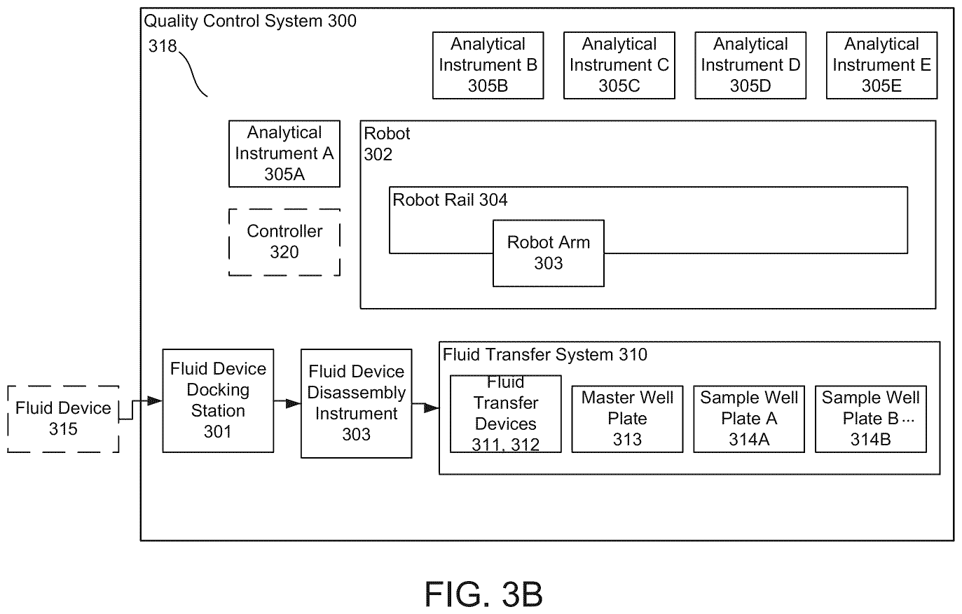

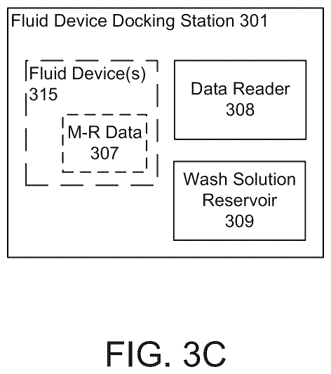

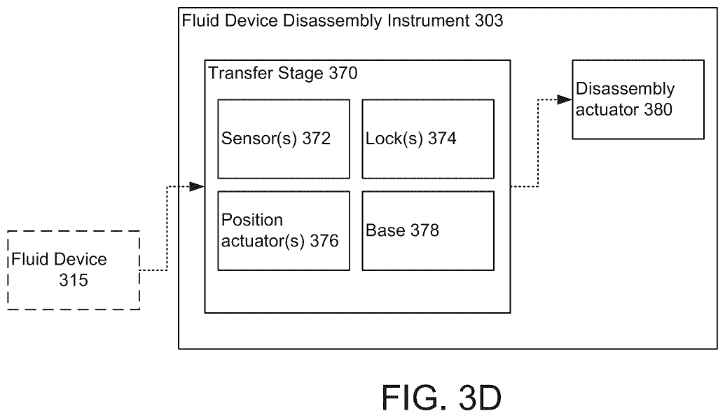

The operational instrument(s) 204 may include one or more instruments (e.g., groups of one or more electrical and/or mechanical components) configured to perform an intermediate sample preparation step (e.g., without contacting the sample), such as disassembling a fluid device 215 (e.g., fluid device disassembly instrument 303 of FIGS. 3A-3D) or disassembling a sample tube (e.g., a tube disassembly instrument).

Moreover, analytical instrument(s) 205 may include instruments configured to perform an analytical operation (e.g., an assay) on a sample. For example, the analytical instrument(s) 205 may include one or more instruments configured to perform a biological assay on the fluid sample. In some variations, the analytical instrument(s) 205 may include one or more of a flow cytometer, a cell counter, a quantitative thermocycler (e.g., qPCR), a fluorimeter, a flow-based bead reader (e.g., multiplex immunoassays), polymerase chain reaction systems (e.g., digital polymerase chain reaction or “dPCR”), cell analyzers, an incubator, and a plate reader (e.g., a microplate reader). In some variations, one or more of the analytical instrument(s) 205 may be off-the-shelf instruments designed for lab environments. In some variations, the analytical instrument(s) 205 may include one or more instruments that are in-use within the QC system 200, as well as one or more backup instruments that are not in-use. These backup instruments may be stored on one or more cart(s) 260, which may be movable between an interior and exterior of the QC system 200. In some variations, any combination of the aforementioned features may be integrated within the QC system 200. For example, all of the aforementioned features may be integrated within the QC system 200. In a particular example, the fluid device docking station 201, device transfer system 240, and operational instrument(s) 204 (e.g., a fluid device disassembly instrument) may be integrated in sequence such that a fluid device 215 may pass from the fluid device docking station 201 to the operational instrument(s) 204 via the device transfer system 240.

The fluid device docking station 201 may include an opening or bay for receiving the fluid device 215 (e.g., transferred from a cell processing system to the QC system 200). In some variations, the fluid docking station 201 may include a door or other covering that may be manually and/or automatically actuated to open and close. The fluid device docking station 201 may be configured to receive the fluid device 215 and transport a fluid sample from within the fluid device to a pipetting reservoir, or similar fluid sample trough, within the fluid transfer system 210. The fluid transfer from the fluid device 215, which may have a sterile liquid transfer port, to the pipetting reservoir may occur by coupling corresponding liquid transfer ports (e.g., sterile liquid transfer ports) on the fluid device 215 and the fluid device docking station 201. The fluid device docking station 201 may further be in fluidic communication with the pipetting reservoir via e.g., tubing and/or other conduits. For example, the fluid device docking station 201 may include controlling features (e.g., a pump module) for pumping fluid sample from the fluid device into the pipetting reservoir. Moreover, in some variations, the QC system 200 may include a plurality of fluid device docking stations 201 such that a plurality of fluid devices 215 may be processed in parallel.

In some embodiments, the robot 202 of the QC system 200 may include one or more devices (e.g., robotic arm(s)) capable of moving consumables (e.g., multiwell plates) and/or the fluid device(s) 215 from one location to another location within the QC system 200. For example, the robot 202 may be capable of moving consumables from the fluid transfer system 210 to one or more analytical instrument(s) 205 so that samples therein may be analyzed. The robot 202 may include a mechanical manipulator (e.g., an arm) in a fixed location, or attached to a linear rail, or to a 2- or 3-dimensional rail system. In some variations, the robot 202 may be a wheeled device. Any number of robots 202 may be used within the QC system 200, such as a plurality of robots 202. For example, in some embodiments, the QC system 200 may include two or more robots 202 of the same or different type (e.g., two robotic arms each independently configured for moving sample well plates between analytical instruments). The robot 202 may also include an end effector for precise handling of different labware components, including consumables, such as multiwell plates (e.g., 6-well plate, 12-well plate, 24-well plate, 96-well plate, 384-well plate, etc.) and reagent transfer vessels (e.g., pipetting reservoirs, centrifuge tubes, microcentrifuge tubes, waste containers for solid/liquid waste, etc.).

The fluid transfer system 210 of the QC system 200 may be configured to obtain a sample from a fluid device 215 and transfer the sample (e.g., a portion thereof, or at least a portion thereof) to one or more well plates prior to analysis. In some embodiments, the fluid transfer system 210 may include an end effector (e.g., one or more end effectors, at least one end effector) configured to transfer fluid samples, which may include at least an aliquot of a fluid sample, from the pipetting reservoir into consumables and/or between consumables. In some variations, the at least one end effector may be an automated liquid handler comprising a pipettor, such as a multi-channel pipettor, for dispensing fluid into the consumables. The consumables may comprise plasticware such as multiwell plates (e.g., 6-well plate, 12-well plate, 24-well plate, 96-well plate, 384-well plate, etc.), centrifuge tubes, microcentrifuge tubes, and the like. In some variations, the at least one end effector may include a mechanical device capable of transporting fluid samples, or fluid sample aliquots, from the pipetting reservoir into consumables and/or between consumables. The mechanical device may be configured to manipulate a set of pipettors, including multi-channel pipettors. In some variations, the at least one end effector may include some or all of the same features as that of the robot 202. In some variations, the at least one end effector may include two end effectors, each one configured to perform a step in a sequential process. For example, a first end effector, or first fluid transfer device, may be configured to transport fluid sample from a pipetting reservoir to a first multiwell plate, and a second end effector, or second fluid transfer device, may be configured to transport fluid sample from the first multiwell plate to one or more second well plates.

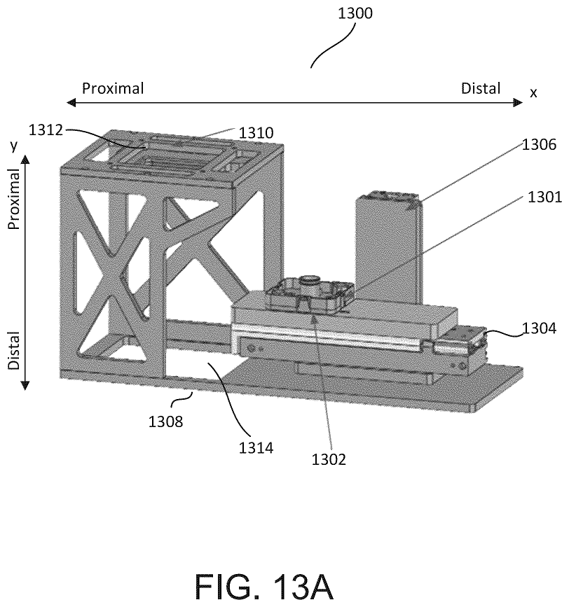

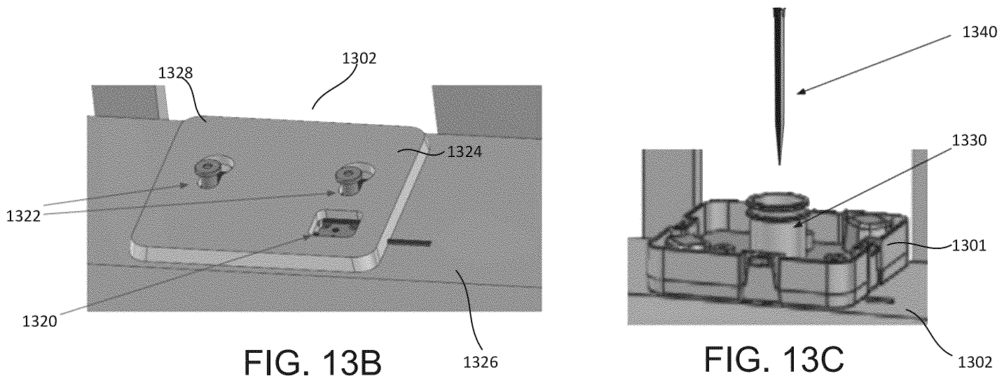

Further, in some variations, the QC system 200 may include capable of moving other components (e.g., the fluid device(s) 215, sample tube racks, sample tubes, and/or the like) from one location to another location within the QC system 200. For example, the QC system 200 may include a device transfer system 240, described in more detail with respect to FIGS. 13A and 13B, for automatically transferring the fluid device(s) 215 within the QC system 200. That is, the device transfer system 240 may include one or more automated pathways to guide the fluid device(s) between components of the QC system 200. Each automated pathway may include, for example, a feedthrough conveyor system for advancing the fluid device(s) 215 from an origin to a destination. In some variations, the device transfer system 240 may include a first pathway (or partial pathway) between the fluid device docking station 201 and an operational instrument 204 and/or the robot 202. In one example, the first pathway may guide the fluid device(s) from the fluid device docking station 201 to a first operational instrument 204, which may be a fluid device disassembly instrument (described in detail herein with respect to FIGS. 3D and 12A-13B). Briefly, the fluid device disassembly instrument may be configured automate the disassembly of a closed-loop container (e.g., a fluid device 215), which may reduce operational time, risk of sample contamination, and risk of sample tracking errors compared to manual disassembly processes. In particular, the fluid device disassembly instrument may be configured to receive the fluid device(s) thereon (e.g., on a transfer stage thereof), transfer the fluid device(s) 215 (e.g., via the transfer stage) to a disassembly actuator, and disassemble the fluid device(s) 215 (e.g., remove a cap or collar from a container of the fluid device(s) 215) via the disassembly actuator to expose the fluid sample therein.

More specifically, the fluid device(s) 215 may include a first portion, which may be a collar or cap, configured to releasably couple to a second portion, which may be a container. The second portion may be configured to hold a volume of fluid and the first portion may be configured to control fluid transfer in and out of the second portion, and to engage with various components of the cell processing systems and QC systems herein. In general, the fluid device(s) 215 may be closed-loop systems designed to automatically regulate an internal environment (e.g., a pressure within the container) such that the first portion may remain coupled to the second portion during cell processing within the cell processing systems herein. However, as explained above, to access the fluid within the container for analysis with the QC system 200, the first portion may need to be removed from the second portion. When the first portion is not coupled to the second portion, a fluid sample within the second portion may be exposed, allowing other components of the QC system 200, like the fluid transfer system 210, to retrieve or otherwise manipulate the fluid sample (e.g., at least a portion thereof), for analysis.

Illustrative renderings of a fluid device 1100 are depicted in FIGS. 11A and 11B. The fluid device 1100 may include a container 1110 and a collar 1120. The container 1110 may include an opening 1112 and at least one collar coupling feature 1103. For example, the coupling feature 1103 may facilitate a snap and/or press fit between the collar 1120 and the container 1110. The collar 1120 may include a liquid transfer port 1124 (e.g., a sterile liquid transfer port) configured to couple to complementary liquid transfer ports within the cell processing systems herein. Additionally, the collar 1120 may include one or more engagement features 1128, which may facilitate engagement with other components of the QC systems herein, such as the robot (e.g., robot 202 of FIG. 2) and/or the fluid device disassembly instrument (e.g., fluid device disassembly instrument 303 of FIG. 3D). Further, the collar 1120 may include at least one container coupling feature 1102 couplable to a corresponding one of the at least one collar coupling feature 1103 of the container 1110.

In some embodiments, as introduced above, the container coupling feature 1102 is releasably couplable to the collar coupling feature 1103 of the container 1110. The container coupling feature 1102 and the collar coupling feature 1103 may be universally designed such that containers are interchangeably couplable to the collar 1120. In this way, a collar 1120 may be used with any size and shape container 1110. In some variations, a range of containers capable of holding a range of fluid volumes may be used. For example, the container 1110 may be capable of holding about 1 mL to about 1 L, or at least about 1 mL, at least about 2 mL, at least about 3 mL, at least about 4 mL, at least about 5 mL, at least about 10 mL, at least about 15 mL, at least about 20 mL, at least about 25 mL, at least about 50 mL, at least about 100 mL, at least about 200 mL, at least about 250 mL, at least about 500 mL, at least about 750 mL, or up to about 2.5 mL, up to about 5 mL, up to about 7.5 mL, up to about 10 mL, up to about 12.5 mL, up to about 15 mL, up to about 17.5 mL, and/or up to about 20 mL (including all ranges and subranges therebetween). In one example, the container 1110 may be configured to hold a volume of about 10 mL. In some variations, the opening 1112 of the container 1110 may be couplable to a fluid transport feature (not shown) of the collar 1120. To this end, the opening 1112 and the fluid transport feature may be couplable by a threaded interface, a compression fit, a press fit, a friction fit, a luer fit, or couplable by another suitable coupling method that permits fluid transfer between the container 1110 and the collar 1120 without fluid leaks and/or contamination.

In some embodiments, the one or more engagement features 1128 of the collar 1120 may be engageable by a robot of a QC system to move and otherwise manipulate the fluid device 300 within the workcell. This may allow for automated pick and place of the fluid device 1100 within the QC system. Further, the different storage orientations with a reagent vault of the QC system may be achieved using the one or more engagement features 1128. For instance, the one or more engagement features 1128 of the collar 1120 may be configured to allow for hanging the fluid device 1100 in e.g., an inverted orientation with the reagent vault. In some variations, the one or more engagement features 1128 may be at least one depression and/or protrusion within or on a surface of the collar 1120.

Similarly, in some variations, the container 1110 may include one or more engagement features configured or configurable to permit an orientation on an operational instrument of the QC system, such as on a fluid device disassembly instrument. In one example, an exterior bottom surface 1104 (e.g., underside) of the container 1110 may include one or more engagement mechanisms configured to releasably engage with a transfer stage of a fluid device disassembly instrument. As will be described in detail herein, the transfer stage may be a mobile stage configured to position fluid device 1100, when coupled thereto, adjacent a disassembly actuator during disassembly of the fluid device within the QC systems herein. To couple the fluid device 1100 to the transfer stage, the exterior bottom surface 1104 thereof may include one or more recesses (e.g., a plurality thereof) configured to receive one or more complementary projections (e.g., locking pins) from the transfer stage.

Additional details regarding sterile liquid transfer ports, fluid transfer, and aspects thereof are provided e.g., in U.S. patent application Ser. No. 17/198,134, published as U.S. Patent Publication No. 2021/0283565, and entitled “Systems and Methods for Cell Processing U.S. patent application Ser. No. 18/620,826, entitled “Systems, Devices, and Methods for Fluid Transfer Within an Automated Cell Processing System”, and U.S. Provisional Patent Application No. 63/524,596, entitled “Systems, Devices, and Methods for Fluid Transfer Within an Automated Cell Processing System”, the contents of each which are incorporated by reference herein, the contents of each of which was previously incorporated by reference herein.

Referring again to FIG. 2, the QC system 200 may additionally include one or more storage compartments or areas, such as one or more of the reagent storage compartment 235, the labware storage compartment 245, and the instrument storage area 255.

The reagent storage compartment 235 may be used to store cell culture media, assay controls, and assay reagents. Additionally, the reagent storage compartment 235 may store reagents including, but not limited to, buffer, cytokines, proteins, purified proteins, enzymes, polynucleotides, transfection reagents, non-viral vectors, viral vectors, dyes, antibodies, antibiotics, nutrients, cryoprotectants, solvents, cellular materials, small molecules, pharmaceutically acceptable excipients, and combinations thereof. Additionally, or alternatively, waste may be stored in the reagent storage compartment 235, or within a fluid device 215 within the reagent storage compartment 235. The reagent storage compartment 235 may include one or more controlled temperature compartments (e.g., freezers, coolers, water baths, warming chambers, or others, at e.g., about −80° C., about −20° C., about 4° C., about 25° C., about 30° C., about 37° C., and about 42° C.). Temperatures in these compartments may be varied during automated QC workflows to heat or cool reagents. In some variations, the reagent storage compartment 235 may be accessible by a user for manual loading and unloading. Additionally, or alternatively, the reagent storage compartment 235 may be accessible by the robot 202. In particular, reagents may be loaded into and unloaded from the reagent storage compartment 235 by the robot 202.

The labware storage compartment 245 may be used to store consumables, such as different types of disposable labware and plasticware, including multiwell plates (e.g., 6-well plate, 12-well plate, 24-well plate, 96-well plate, 384-well plate, etc.), reagent transfer vessels (e.g., pipetting reservoirs, centrifuge tubes, microcentrifuge tubes, waste containers for solid/liquid waste, etc.), and fluid transfer tools (e.g., pipette tips, pipette tip racks, pipettors (i.e., multi-channel pipettors), etc.).

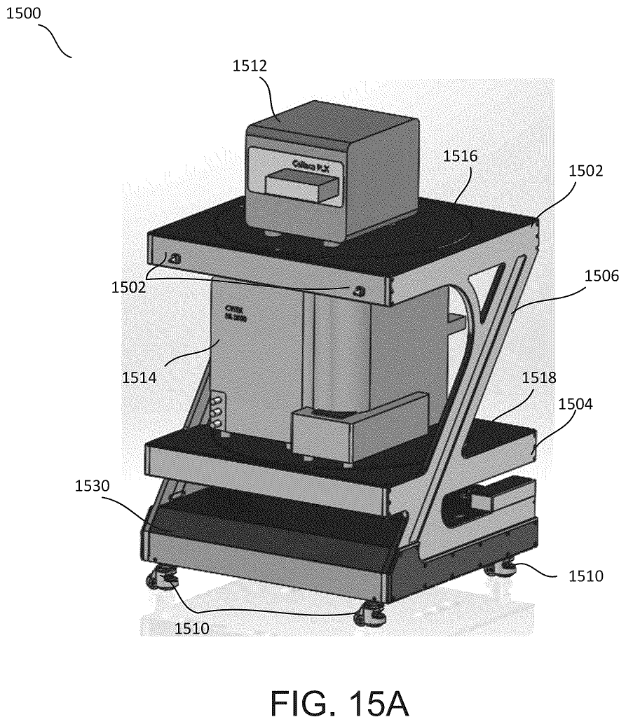

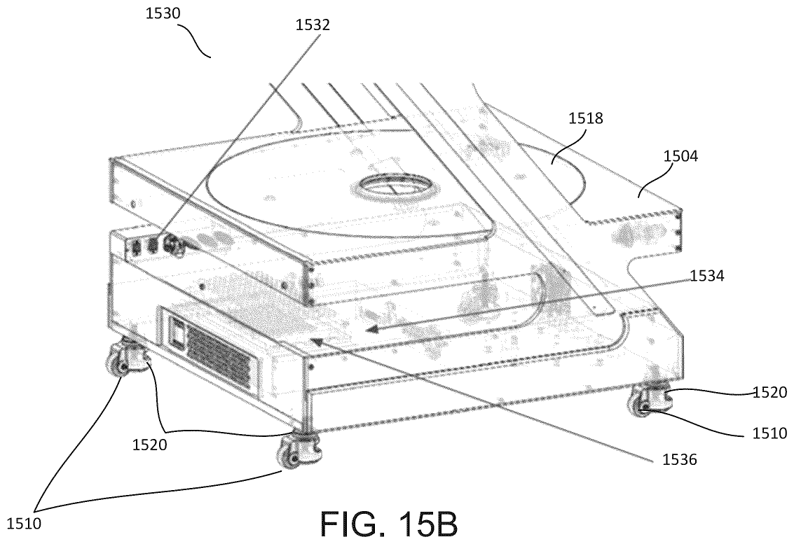

The instrument storage area 255 may be a closet or other designated area within the QC system 200 where backup or replacement instruments (e.g., analytical and/or operational instruments) may be stored. For example, if a first, in-use analytical instrument 205 needs to be exchanged (for a same or different analytical instrument 205), the instrument storage area 255 may conveniently provide a second, backup instrument for the exchange. Accordingly, the instruments within the instrument storage area 255 may to provide redundancy if one or more in-use instruments of the QC system 200 require maintenance or replacement. In some variations, the instrument storage area may be configured to house one or more cart(s) 260, such as a plurality thereof (e.g., 2, 3, 4, 5, 6, 7, 8, 9, 10, or more than 10 carts 260). The cart(s) 260 may be mobile (e.g., wheeled) carts configured to carry one or more backup instruments thereon. In particular, the cart(s) 260 may be configured to be moved (e.g., by an operator) between the instrument storage area 255 and an instrument access point (e.g., an instrument docking station) to facilitate exchanging an in-use instrument for a backup or replacement instrument. As is described in detail with respect to FIGS. 15A and 15B, each of the cart(s) 260 may include features to facilitate transport of and access to instruments on the cart. For example, each instrument support surface of a cart 260 may include a turntable configured to rotate an instrument thereon relative to a stationary cart body. As another example, each cart 260 may include a shock absorbing system to stabilize each instrument support surface of the cart 260.

In some variations, the QC system 200 may include an enclosure configured to house one or more of the QC system elements described herein. For example, the enclosure may surround (temporarily or permanently) any combination (including all) of the fluid device docking station 201, the robot 202, the operational instrument(s) 204, the analytical instruments(s) 205, the fluid transfer system 210, the device transfer system 240, the controller 220, the fluid device 315, the reagent storage compartment (or reagent vault) 235, the labware storage compartment 245, the instrument storage area 255, and the cart(s) 260. In some variations, the enclosure may at least partially surround (temporarily or permanently) any combination (including all) of the aforementioned features of the QC system 200.

In some variations, only a portion of the controller 220 of the QC system 200 may be located within the enclosure. For example, the one or more processors of the controller 220 may be within the enclosure while the display and the input device are remotely located. Optionally, the display and the input device may reside within the enclosure and may be accessible to a user. The one or more processors of the controller 220 may also be remotely located and configured to transmit controlling instructions to the QC system 200 to implement a QC workflow.

The enclosure may provide a HEPA-filtered environment to maintain the sterility of fluid samples therein. In some variations, or more areas within the enclosure may be configured for use in a clean room, a biosafety cabinet, or other sterile location. Additionally, in some variations, one or more areas within the enclosure (e.g., the fluid device docking station 201) may be configured to be sterilized periodically, such as via an integrated sterilization system (e.g., including a sterilant source, fluid source, and a pump to deliver a sterilant, such as vaporized hydrogen peroxide, to the given area).

Moreover, the enclosure may be any suitable shape, such as cubic, rectangular, spherical, pyramidal, irregular, etc. In general, the dimensions of the enclosure of the QC system 200 may be about equal to or less than the dimensions of a workcell enclosure of the cell processing systems herein (e.g., workcell 105 of FIGS. 1A and 1B). For example, the enclosure of the QC system 200 may have a maximum height, width, and/or length of about 3 ft to about 40 ft, such as about 5 ft to about 30 ft, about 7 ft to about 25 ft, about 9 ft to about 20 ft, or about 10 ft to about 15 ft (including all ranges and subranges therebetween).

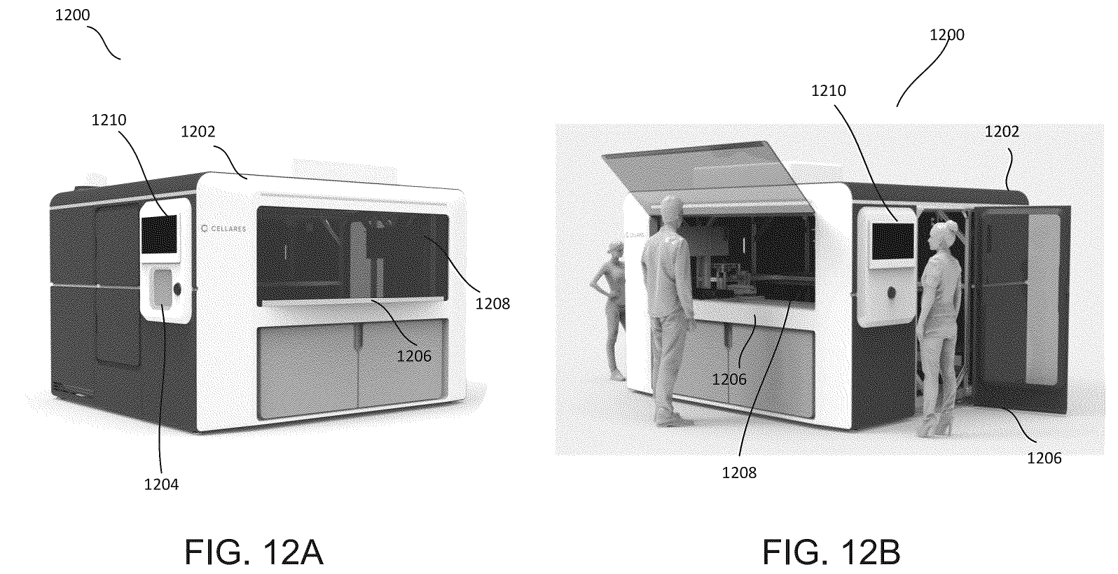

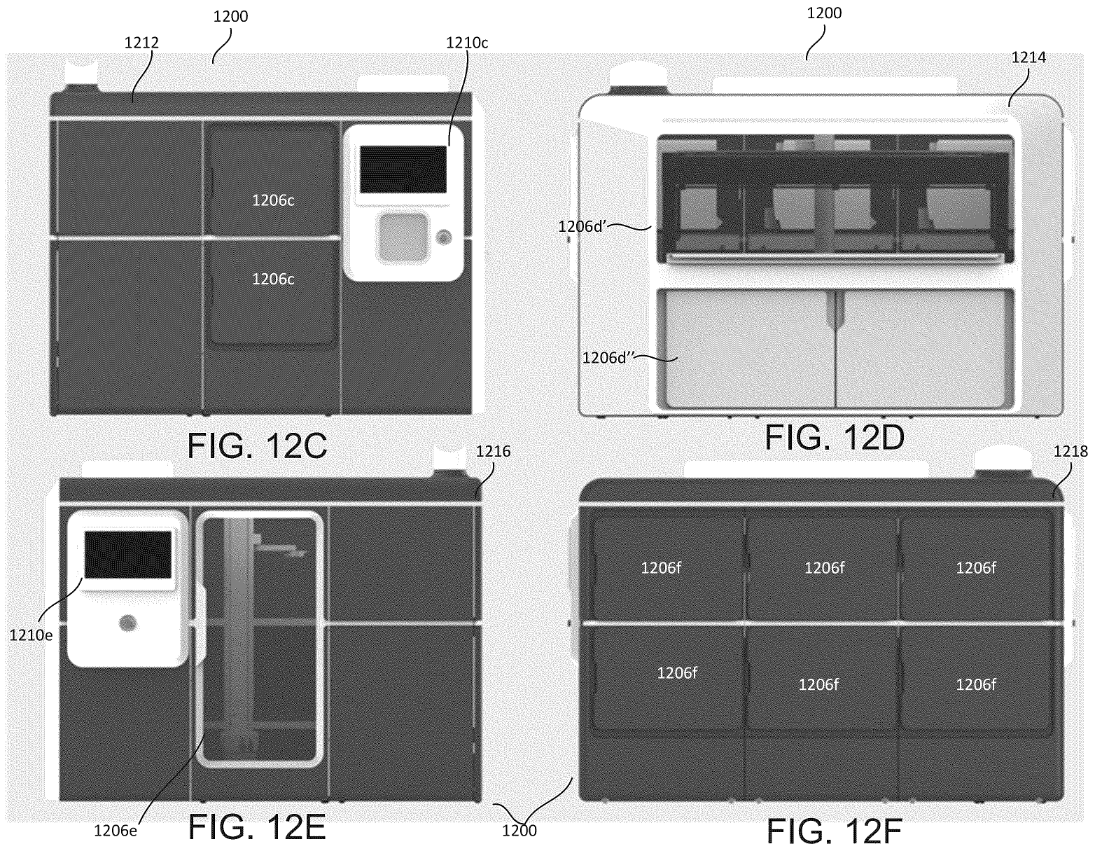

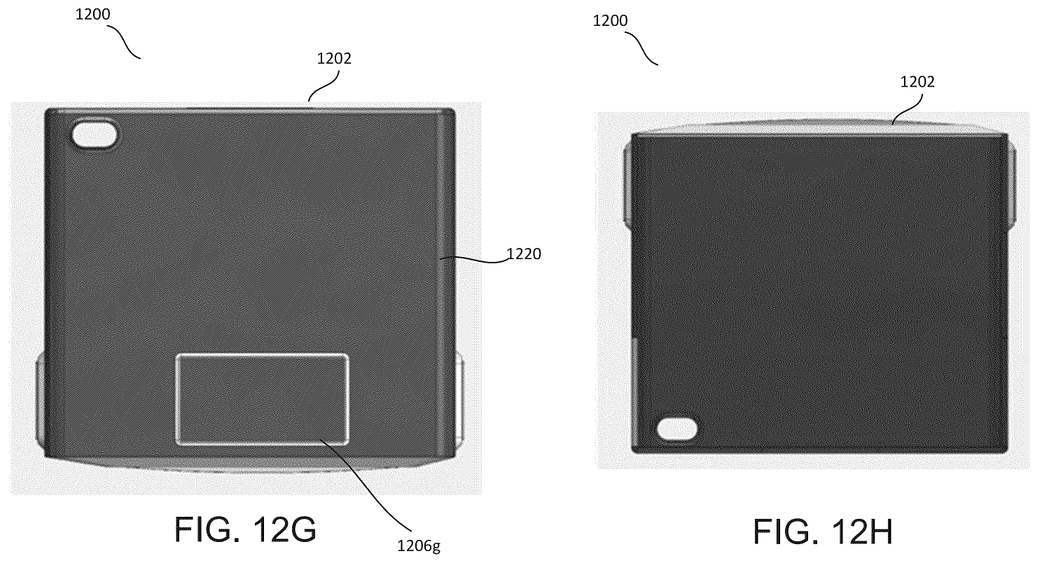

Referring briefly to FIGS. 12A-12H, various views of an exemplary QC system 1200, having an enclosure 1202, are depicted. FIGS. 12A and 12B show two perspective views of QC system 200. The enclosure 1202 may include a fluid device docking station 1204 configured to receive a sample (e.g., a fluid sample within a fluid device). In some variations, the fluid device docking station 1204 may be configured to enclose the sample therein during a sterilization procedure (e.g., using a vapor sterilant) to maintain the sterility of the sample (e.g., after it is removed from a workcell of a cell processing system). The fluid device docking station 1204 may extend through any sidewall of the enclosure 1202. As an example, FIG. 12C is a first sideview of the QC system 1200 showing the fluid device docking station 1204 on a first sidewall 1212 of the enclosure 1202. In some variations, one or more feedthroughs, such as a plurality of feedthroughs, may be located on one or more sidewalls of the enclosure 1202 (e.g., such that a plurality of samples may be received in parallel).

Additionally, the enclosure 1202 may include one or more access points 1206 (e.g., one or more windows, entrances, hoods, drawers, cabinets, and/or the like) to allow a user to observe and/or access an interior zone 1208 of the enclosure 1202. As shown in FIG. 12C, first and second access points 1206c may be located on the first sidewall 1212. FIG. 12D is a second sideview of the QC system 1200 showing third and fourth access points 1206d′, 1206d″ within a second sidewall 1214 of the enclosure 1202. FIG. 12E is a third sideview of the QC system 1200 showing a fifth access point 1206e within a third sidewall 1216 of the enclosure 1202. FIG. 12F shows a fourth sideview of the QC system 1200 including sixth, seventh, eight, ninth, tenth, and eleventh access points 1206f on a fourth sidewall 1218 of the enclosure 1202. Additionally, FIG. 12G shows a top view of the QC system 1200 including twelfth access point 1206g on an upper wall 1220 of the enclosure 1202, Any of the access points 1206c-1206g may be configured to be transitioned from a first (e.g., closed) configuration to a second (e.g., open) configuration to allow operator access to an instrument within the enclosure 1202 and/or to the interior zone 1208. For example, one or more of the access points 1206c-1206g may provide access to a dock for an analytical instrument. Thus, in some variations, the analytical instrument of the given dock may be exchanged for another (same or different) analytical instrument via one or more of the access points 1206c-1206g (e.g., via access points 1206c, 1206d″, and/or 1206g). As another example, one or more of the access points 1206 may allow an operator to view and/or enter the interior zone 1208. In some variations, access points 1206d′ and 1206e may be a window and an entrance, respectively, configured to allow access to the interior zone 1208. As yet another example, one or more of the access points may allow an operator to view and/or enter an electronics hub of the QC system 1200. In some variations, the access points 1206d″ and/or 1206g may be configured to allow access to two electronics hubs (not shown) for maintenance and repair purposes.

Further, the enclosure 1202 may include a display 1210 thereon, which may be communicably coupled to a controller. The display 1210 may show data (e.g., real-time assay results and/or electronic cell product records) for each of one or more samples being processed within the QC system 200. In some variations, the enclosure 1202 may support one or more displays, such as a plurality of displays, thereon to improve data visibility. For example, as shown in FIGS. 12C and 12E, a first display 1210c is mounted on the first sidewall 1212, and a second display 1210e is mounted on the third sidewall 1216. Additionally, the interior zone 1208 may include one or more storage areas or containers, such as an instrument storage area (not shown) where one or more mobile carts (e.g., supporting backup analytical instruments) may be stored. In some variations, the one or more carts may be configured to be transferred in and out of an access point 1206 (e.g., access point 1206e). Finally, FIG. 12H shows a bottom view of the enclosure 1202 of the QC system 1200. While FIGS. 12A-12H show one exemplary arrangement of features of the enclosure 1202, it should be understood that the aforementioned features may be arranged in any suitable way with respect to the enclosure 1202.

Turning back to FIG. 2, in some embodiments, the controller 220 of the QC system 200 may include, as described further with reference to FIG. 3A, one or more of a processor, a memory, a communication device, an input device, and, optionally, a display that may be communicatively coupled to the controller 220 (and, in some variations, not residing therein). The display may be local to an enclosure of the QC system 200 or may be remotely located. The controller 220 may be configured to control (e.g., operate) one or more processes (e.g., all processes) of QC system 200. For example, the controller 220 may be communicably coupled to and configured to control one or more (e.g., each) of the fluid device docking station 201, the robot 202, the operational instrument(s) 204, the analytical instruments(s) 205, the fluid transfer system 210, and the device transfer system 240. As will be described with reference to FIG. 3C, the controller 220 may be configured to obtain a sample-ID (e.g., via a barcode) of a fluid sample from a fluid device 215 within the fluid device docking station 201 and/or along the device transfer system 240. The controller 220 may be configured to control the fluid transfer system 210 to transfer fluid sample between the fluid device within the fluid device docking station 201 and consumables within the fluid transfer system 210, the transferring being performed according to a QC workflow associated with a particular analytical instrument 205. The controller 220 may be configured to control the robot 202 to move fluid samples within consumables (e.g., multiwell plates) between the fluid transfer system 210 and the analytical instrument(s) 205. The controller 220 may also be configured to transmit results output from the analytical instrument(s) 205 to a remote computing device (e.g., mobile device, user workstation, cloud-based application, etc.) for further review and processing by a trained professional.

In some variations, the QC system 200 may additionally include one or more integrated tools for sample and/or reagent management. For example, the tools may include one or more of a temperature-controlled plate agitator, as assay plate preparation area, a plate thawing station (for sample and reagent preparation), and the like.

Aspects of an illustrative QC system will be described in more detail and with context to a generalized QC workflow and with reference to FIGS. 3A-3D.

As shown in FIG. 3A, QC system 300 may include a controller 320, a fluid device docking station 301, a fluid transfer system 310, a robot 302, and an analytical instrument(s) 305. In some variations, the QC system 300 may include one or more of a reagent storage compartment (not shown), a labware storage compartment (not shown), and an instrument storage area (not shown), as well as one or more carts (not shown). Additionally, or alternatively, required reagents, consumables and/or instruments may be provided in real-time by a user.

The controller 320 may be configured to electronically integrate the QC system 300. For example, the controller may be configured to use data received from one or more components of the QC system 300 to inform real-time processing instructions transmitted to one or more same or different components of the QC system 300. In some variations, the controller 320 may include a plurality of controllers 320. In some variations, the controller 320 may be a same controller used to operate one or more cell processing systems associated with the QC system 300.

In general, a given controller 320 may comprise one or more of a processor 322, a memory 324, a communication device 326, an input device 328, and, optionally, a display 330, which may be communicatively coupled to the controller 320. In some variations, the QC system 300 may include a plurality of one or more of the processor 322, memory 324, communication device 326, input device 328, and the display 330. The display 330 is dashed in FIG. 3A to indicate that it may be local to an enclosure of the QC system 300 or may be located remotely.

In some variations, the processor 322 of the controller 320 described herein may process data and/or other signals to control one or more components of the QC system 300. The processor 322 may be configured to receive, process, compile, compute, store, access, read, write, and/or transmit data and/or other signals. Additionally, or alternatively, the processor 322 may be configured to control one or more components of a device (e.g., console, touchscreen, personal computer, laptop, tablet, server).

In some variations, the processor 322 may be configured to access or receive data and/or other signals from one or more of a cell processing system (as shown in FIG. 1A and FIG. 1B), the fluid device docking station 301, the fluid transfer system 310, the robot 302, the analytical instrument(s) 305, a server, a controller, and a storage medium (e.g., memory, flash drive, memory card, database). In some variations, the processor 322 may be any suitable processing device configured to run and/or execute a set of instructions or code and may include one or more data processors, image processors, graphics processing units (GPU), physics processing units, digital signal processors (DSP), analog signal processors, mixed-signal processors, machine learning processors, deep learning processors, finite state machines (FSM), compression processors (e.g., data compression to reduce data rate and/or memory requirements), encryption processors (e.g., for secure wireless data transfer), and/or central processing units (CPU). The processor 322 may be, for example, a general-purpose processor, Field Programmable Gate Array (FPGA), an Application Specific Integrated Circuit (ASIC), a processor board, and/or the like. The processor 322 may be configured to run and/or execute application processes and/or other modules, processes and/or functions associated with the QC system 300.

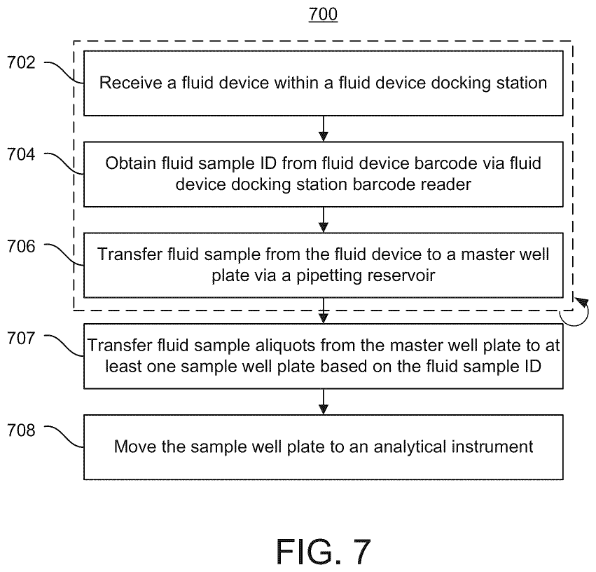

The systems, devices, and/or methods described herein, such as those that will be described with reference to FIGS. 7-9B, may be performed by software (executed on hardware), hardware, or a combination thereof. Hardware modules may include, for example, a general-purpose processor (or microprocessor or microcontroller), a field programmable gate array (FPGA), and/or an application specific integrated circuit (ASIC). Software modules (executed on hardware) may be expressed in a variety of software languages (e.g., computer code), including structured text, typescript, C, C++, C#, Java®, Python, Ruby, Visual Basic®, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. Additional examples of computer code include, but are not limited to, control signals, encrypted code, and compressed code.

In some variations, the memory 324 of the controller 320 may be configured to store data and/or information. In some embodiments, the memory 324 may include one or more of a random-access memory (RAM), static RAM (SRAM), dynamic RAM (DRAM), a memory buffer, an erasable programmable read-only memory (EPROM), an electrically erasable read-only memory (EEPROM), a read-only memory (ROM), flash memory, volatile memory, non-volatile memory, combinations thereof, and the like. In some embodiments, the memory 324 may store instructions to cause the processor 322 to execute modules, processes, and/or functions associated with the device, such as image processing, image display, sensor data, data and/or signal transmission, data and/or signal reception, and/or communication. Some embodiments described herein may relate to a computer storage product with a non-transitory computer-readable medium (also may be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The computer code (also may be referred to as code or algorithm) may be those designed and constructed for the specific purpose or purposes. In some embodiments, the memory 324 may be configured to store any received data and/or data generated by the controller 320 and/or the cell processing system. In some embodiments, the memory 324 may be configured to store data temporarily or permanently.

In some variations, the input device 328 of the controller 320 may comprise or be coupled to a display 330. Input device 328 may be any suitable device that is capable of receiving input from a user, for example, a keyboard, buttons, touch screen, etc. For example, the display 330, which may include the input device 328, may provide the user with possible assay orders to be executed. The user may then select which assay order should be executed first and may also provide additional instructions before the automated analysis is initiated. As will be described later, this user input may provide grouping information for orchestrating the assay workflow. The input device 328 may include at least one switch configured to generate a user input. For example, an input device 328 may include a touch surface for a user to provide input (e.g., finger contact to the touch surface) corresponding to a user input. An input device 328 including a touch surface may be configured to detect contact and movement on the touch surface using any of a plurality of touch sensitivity technologies including capacitive, resistive, infrared, optical imaging, dispersive signal, acoustic pulse recognition, and surface acoustic wave technologies. In embodiments of an input device 328 including at least one switch, a switch may have, for example, at least one of a button (e.g., hard key, soft key), touch surface, keyboard, analog stick (e.g., joystick), directional pad, mouse, trackball, jog dial, step switch, rocker switch, pointer device (e.g., stylus), motion sensor, image sensor, and microphone. A motion sensor may receive user movement data from an optical sensor and classify a user gesture as a user input. A microphone may receive audio data and recognize a user voice as a user input. The input device 328 and/or the display 330 may be located within an enclosure of the QC system 300 or may be located remotely at, e.g., a computer workstation.

Image data may be output on the display 330. In some variations, the display 330 may include at least one of a light emitting diode (LED), liquid crystal display (LCD), electrolumines cent display (ELD), plasma display panel (PDP), thin film transistor (TFT), organic light emitting diodes (OLED), electronic paper/e-ink display, laser display, and/or holographic display.

In some variations, the display 330 may be configured to display a graphical user interface (GUI). In some variations, the GUI may allow for real-time process monitoring and automatic generation of electronic records for each cell product being processed. For example, the GUI may be configured to receive user input to generate one or more electronic records for a cell product. The GUI may be configured for designing a QC workflow and monitoring a cell therapy product through the QC workflow in real time. For example, the GUI may be a QC workflow design home page. The GUI may indicate that no QC workflows have been selected or loaded. A create icon (e.g., “Create a Process”) may be selectable for a user to begin a QC workflow design process. In some variations, the GUI may include a plurality of dashboards, such as a dashboard indicating (e.g., with text, numbers, and/or graphics) parameters, reagents, operator workflow, and conditional execution of the workflow. In the conditional execution dashboard, one or more QC testing outputs may be displayed, along with a recommendation to modify or maintain the current operator workflow given the outputs. For example, the conditional execution dashboard may display an action such as “continue with current module” for the given cell product. Additionally, the GUI may show one or both of a summary of the realized workflow progress and a summary of the forecasted workflow progress (e.g., over a future timeframe, such as a set of consecutive or nonconsecutive days between about 0 days and 2 weeks in the future). An operator may input data, such as clinical decisions made based on recommendations from the GUI to update the operator workflow.

In some variations, the QC system 300 may optionally include one or more output devices in addition to the display 330, such as, for example, an audio device and haptic device. An audio device may audibly output any system data, alarms, and/or notifications. For example, the audio device may output an audible alarm when a malfunction is detected. In some variations, an audio device may include at least one of a speaker, a piezoelectric audio device, a magnetostrictive speaker, and/or a digital speaker. In some embodiments, a user may communicate with other users using the audio device and a communication channel. For example, a user may form an audio communication channel (e.g., VoIP call).

In some variations, the communication device 326 of the controller 320 may be configured to communicate with another controller and one or more databases. The communication device 326 may be configured to connect the controller 320 to another system (e.g., Internet, remote server, database, another QC system, cell processing system) by wired or wireless connection. In some variations, the QC system 300 may be in communication with other devices via one or more wired and/or wireless networks. In some embodiments, the communication device 326 may include a radiofrequency receiver, transmitter, and/or optical (e.g., infrared) receiver and transmitter configured to communicate with one or more devices and/or networks. The communication device 326 may communicate by wires and/or wirelessly.

In some embodiments, the controller 320 of the QC system 300 may be configured to perform dynamic analysis (e.g., assay) scheduling, data management, and/or data analysis for samples being processed within the QC system 300. The dynamic scheduling may be achieved by analyzing processing data for a cell product associated with a given fluid sample scheduled to be analyzed within the QC system 300. For example, real-time updates on operation length for the cell product may inform the loading time for its fluid sample within the QC system 300. In some variations, the control 320 may be communicably coupled to a controller of the cell processing system so that data may be shared between the two systems.

In some variations, the controller 320 may be configured to store data collected during processing (e.g., assay outputs, scheduling data, data management, and/or relevant analyses thereof), and to use the data (e.g., a subset thereof, including all the data) to train or more predictive models (e.g., machine learning models or algorithms) to analyze relationships between the input parameters. In some variations, the one or more predictive models may additionally be trained on patient data, including identification and/or medical data such as age, sex, diagnosis, cell product type, and/or the like. The one or more predictive models may be applied to process management, such as with a dynamic analysis scheduling model, to optimize (e.g., reduce time, resource, and energy inefficiencies) QC during cell processing. The one or more predictive models may include any suitable predictive model, such as, but not limited to, a regression model (e.g., linear regression model, CatBoost regression model, or Poisson regression model), a neural network (e.g., feedforward neural network, recurrent neural network, LSTM, etc.), and/or the like. For example, the one or more predictive models may capture complex and/or nonlinear relationships between input parameters using decision trees and/or boosting (e.g., gradient boosting to combine multiple predictive models). In some variations, the workflow model may handle categorical features, missing values, and/or overfitting.

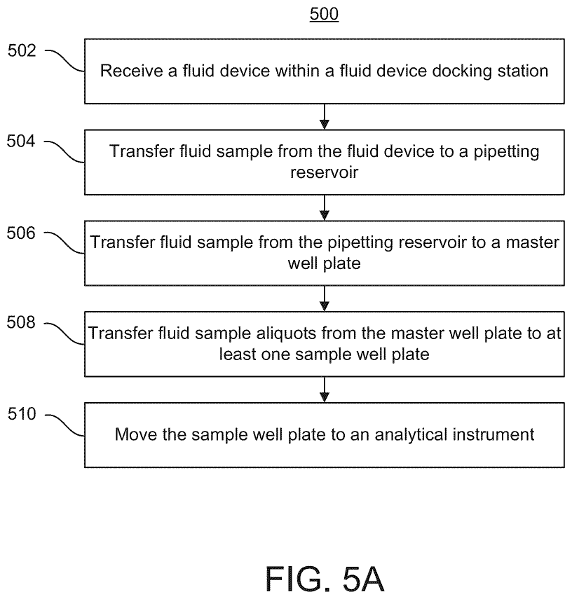

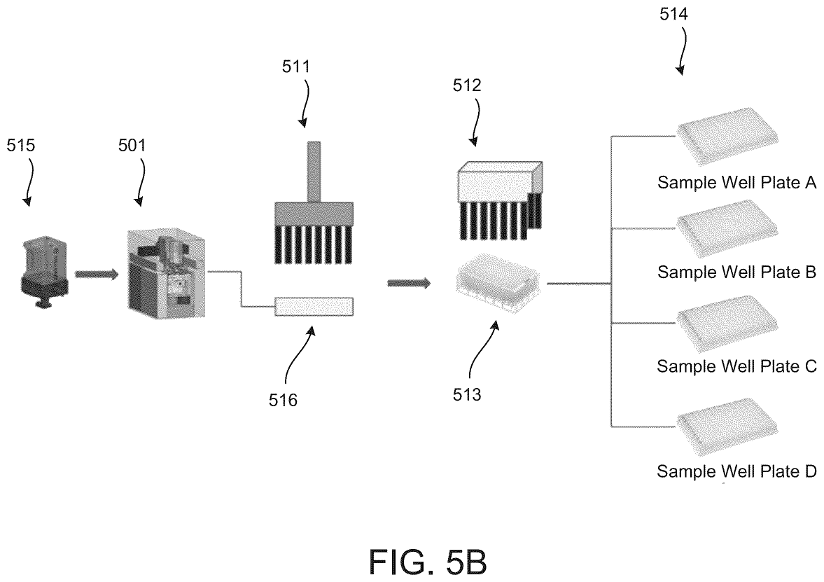

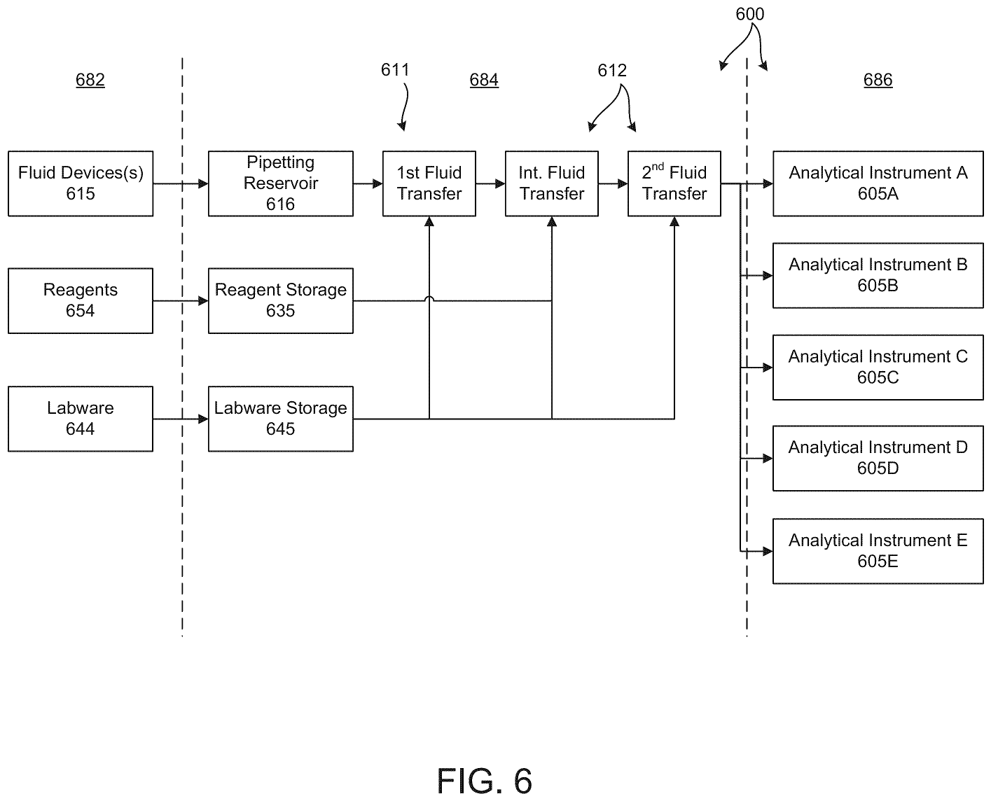

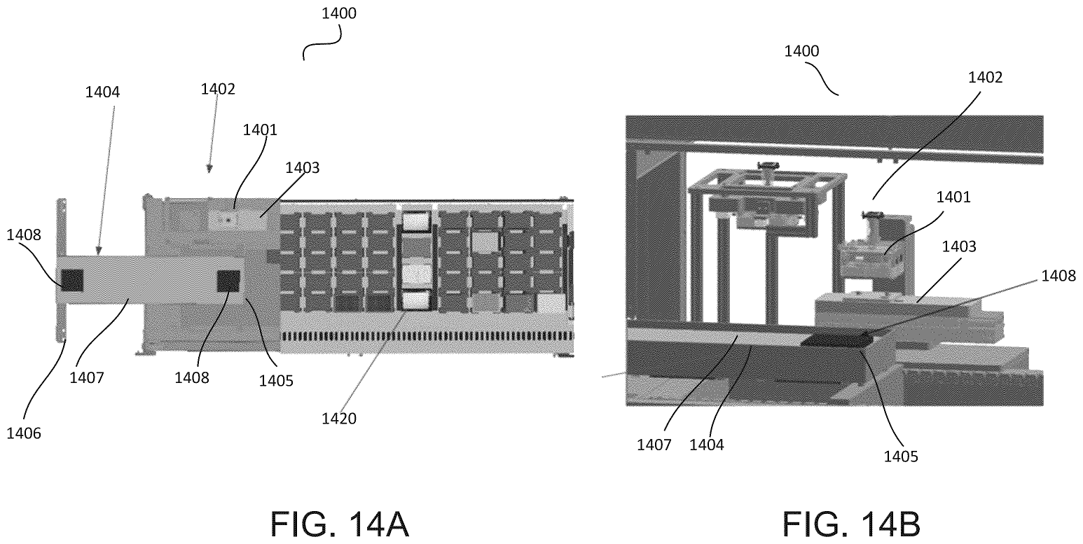

As shown in FIG. 3A, the fluid transfer system 310 of the QC system 300 may include a first fluid transfer device 311, a second fluid transfer device 312, a master well plate 313, and at least one sample well plate 314. The first fluid transfer device 311 and the second fluid transfer device 312 may be similar to the at least one end effector described above with reference to the fluid transfer system 210 of the QC system 200 shown in FIG. 2. The master well plate 313 and the at least one sample well plate 314 may be similar to the multiwell plates described above with reference to the consumables stored within the labware storage component 245 of the QC system 200 shown in FIG. 2. In some variations, the fluid transfer system 310 may include a liquid handler deck or pipette reservoir comprising a pipettor, such as a multi-channel pipettor, for dispensing fluid into the consumables. The fluid transfer system 310 may be configured to prepare fluid samples for analysis such as, for example, by performing DNA isolation for the fluid samples. Fluid transfer between a fluid device within the fluid device docking station 301 and the fluid transfer system 310, including each of the first fluid transfer device 311, the second fluid transfer device 312, the master well plate 313, and the at least one sample well plate 314, will be described in detail with reference to FIG. 5A-6B. In some variations, fluid transfer may occur directly between the fluid transfer system 310 and a fluid device (not shown) disassembled via the fluid device disassembly instrument 303, which is described in detail with respect to FIGS. 13A-13C and FIGS. 14A-14B. In such variations, the fluid device may be transferred from the fluid docking station 301 to the fluid device disassembly instrument 303 via a device transfer system (not shown), such as device transfer system 240 of FIG. 2 (e.g., a conveyor belt). Further, in some variations, the robot 302 may be configured to transfer the fluid device directly between the device transfer system and the fluid device disassembly instrument 303.

In some variations, the robot 302 of the QC system 300 may be similar or identical to the robot 202 of the QC system 200 shown in FIG. 2. As will be shown in FIG. 3B, the robot 302 may be configured to move the at least one sample well plate 314 from the fluid transfer system 310 to the analytical instrument(s) 305.

In some variations, the analytical instrument(s) 305 may comprise an analytical instrument A 305A, an analytical instrument B 305 B, and an analytical instrument C 305C, and the like. The analytical instrument(s) 305 may be one or more instruments configured to perform a biological assay on the fluid sample within the at least one sample well plate(s) 314 received from the fluid transfer system 310 via the robot 302. The analytical instrument(s) 305 may be one or more of a flow cytometer, a cell counter, a quantitative thermocycler (e.g., qPCR), a fluorimeter, a flow-based bead reader (e.g., multiplex immunoassays), polymerase chain reaction systems (e.g., digital polymerase chain reaction or “dPCR”), cell analyzers, an incubator, a plate reader (e.g., a microplate reader), and a Luminex device. Other analytical instruments, as appropriate, may be used.

The QC system 300 of FIG. 3A will now be described with respect to the spatial arrangement shown in FIG. 3B.

In some variations, and as shown in FIG. 3B, the QC system 300 resides primarily within an enclosure 318. The enclosure 318, which may or may not be a sterile enclosure, may house the fluid device docking station 301, the fluid device disassembly instrument 303, the fluid transfer system 310, the robot 302, at least a portion of the controller 320, and the analytical instrument(s) 305, including at least analytical instrument A 305A, analytical instrument B 305B, analytical instrument C 305C, analytical instrument D 305D, and analytical instrument E 305E, which may be the same or different type of instrument. The robot 302 may be centrally located amongst the fluid transfer system 310, the analytical instruments 305A-E, and any storage compartments (e.g., labware storage compartment, reagent storage compartment) that may be included within the enclosure 318. The controller 320 is shown in dashed lines to indicate that its components may be local or remote to the enclosure 318.

In some variations, the fluid transfer system 310 may include fluid transfer devices 311, 312, which may be similar to the first fluid transfer device 211 and the second fluid transfer device 212 described with reference to FIG. 2, a master well plate 313, and at least a sample well plate A 314A and a sample well plate B 314B. It should be appreciated that any number of sample well plates may be used within the fluid transfer system 310, as required by the prescribed analyses to be performed. Each of the sample well plates may be one or more multiwell plates (e.g., 6-well plate, 12-well plate, 24-well plate, 96-well plate, 384-well plate, etc.).

In some variations, the robot 302 may include a robot arm 303 mounted to a robot rail 304 that is centrally located within the enclosure 318. The robot arm 303 may be similar to the mechanical manipulator and end effector described above with reference to FIG. 2. In particular, the end effector of the robot arm 303 may be configured to grasp at least the sample well plate A 314A and the sample well plate B 314B and move each sample well plate 314A, 314B between the fluid transfer system 310 and a prescribed one of the analytical instruments 305A-E. To this end, the robot arm 303 may have any number of degrees of freedom (e.g., 7 degrees of freedom), and the robot rail 304 may be similar to the linear rail and/or 2- or 3-dimensional rail system described above with reference to FIG. 2, as required to enable access to each of the fluid transfer system 310, the analytical instruments 305, and, optionally, the reagent storage compartment and the labware storage compartment that may be arranged within the enclosure 318.

As shown in FIG. 3B, and with reference also to FIG. 3C, the fluid device docking station 301 of the QC system 300 may be configured to receive a fluid device 315. As described above, the fluid device 315 may be provided automatically or manually by a user to the fluid device docking station 301 of the QC system 300.

In some variations, the fluid device 315 may include machine readable data (M-R data) 307, such as a barcode or similar method of communication data (e.g., radiofrequency identification (RFID), near field communication (NFC), etc.), that conveys, when probed by a corresponding reader, fluid sample data, such as a sample-ID, sample volume, and the like, of a fluid sample within the fluid device 315. Accordingly, as shown in FIG. 3C, the fluid device docking station 301 may comprise a data reader 308 and, optionally, a wash solution reservoir 309. In some variations, the data reader 308 may be used to transmit sample data information encoded within the M-R data 307 to the controller 322 to confirm the identity of the fluid device 315. The identity of the fluid device 315 may be used to ensure that each fluid sample is dispensed into appropriate regions of the consumables, thereby enabling tracking of the fluid samples throughout the QC workflow. In some variations, after a fluid transfer from the fluid device 315 to a pipetting reservoir of the QC system 300, a wash solution from the wash solution reservoir 309 may be flowed through relevant conduits to clear them of prior fluid sample. After the fluid device 315 is inserted into the fluid device docking station 301, the data reader 308 may probe the M-R data 307 of the fluid device 315 to obtain fluid sample data relevant to the fluid sample within the fluid device 315. In some variations, and in place of M-R data 307, fluid sample data of a fluid sample within the fluid device 315 may be defined by a user when the fluid device 315 is inserted into the fluid device docking station 301.

In some variations, the QC systems herein may further include another data reader configured to track one or more fluid samples after analysis, once they have been transferred to a sample tube. For example, the data reader may be a scanning sensor within the device transfer system 240 (e.g., a conveyor thereof) configured to detect a bar code for sample tubes within a tube rack being transferred by the device transfer system 240. Additionally, or alternatively, the data reader may be configured to track one or more reagents stored in sample tubes within a sample tube rack. Further, the data reader may be configured to detect a barcode for one or more labware and/or instrument components delivered to the QC system 200.

The fluid device disassembly instrument will now be described in detail below with reference to FIG. 3D, FIGS. 13A-13C, and FIGS. 14A-14B.

FIG. 3D is an illustrative schematic of the fluid device disassembly instrument 303. The fluid device 315 may be transferred to the fluid device disassembly instrument 303 via one or both of a device delivery system (e.g., device delivery system 240 of FIG. 2) and the robot 302. In some variations, the robot 302 (not shown) may be configured to transfer the fluid device 315 (e.g., via one or more engagement mechanisms, such as engagement mechanisms 1128 of FIG. 11A) directly to the transfer stage 370 of the fluid device disassembly instrument 303. The transfer stage 370 may be a movable stage that is configured to be translated along one or more axes, such as bidirectionally translated along both of a horizontal and a vertical axis. One or more position actuator(s) 376 may be configured to move the transfer stage 370 along a given axis, as is described in detail below. In general, the purpose of repositioning the transfer stage 370 may be to position the fluid device 315 thereon proximal to (e.g., within) a disassembly actuator 380 of the fluid device disassembly instrument 303 (e.g., prior to disassembly of the fluid device 315), and/or to at least a portion of the fluid device 315 thereon (e.g., a container thereof) distal to the disassembly actuator 380 (e.g., after disassembly of the fluid device 315). The disassembly actuator 380 may be configured to apply a force, such as a compressive force or a tension force, to the fluid device 315 (e.g., to a collar thereof), to disassemble the fluid device 315, which may include decoupling a collar from a container of the fluid device 315. In some variations, the disassembly actuator 308 may be a pneumatic actuator. In some variations, the disassembly actuator 308 may include one or more protrusions, such as one or more hooks, configured to releasably engage one or more complementary recesses on the fluid device 315 (e.g., on the collar thereof). The fluid device 315 is shown in dashed lines to indicate that its components may be local or remote to the fluid device disassembly instrument 303, such as to one or both of the transfer stage 370 and the disassembly actuator 380.

The transfer stage 370 may also be configured to detect and secure the fluid device 315 thereto. For example, the transfer stage 370 may include one or more sensors 372 within a base 378 of the transfer stage 370 to detect a presence of the fluid device 315 relative to the transfer stage 370, such as one or more of a proximity sensor, force sensor, torque sensor, optical sensor, motion sensor, temperature sensor, and the like. In some variations, the sensor(s) 372 may include at least one proximity sensor, such as one or two proximity sensors, within the base 378. Once the fluid device 315 is detected, transfer stage 370 may secure the fluid device thereto via a lock mechanism, such as via one or more lock pins and fasteners. In some variations, the lock mechanism may include a plurality of locking pins, such as two locking pins, configured to extend above a top surface of the transfer stage 370 and couple to an exterior bottom surface of the fluid device 315 (e.g., within a plurality of corresponding recesses therein).

In some variations, the QC systems herein may include a plurality of fluid device disassembly instruments, such as 2, 3, 4, 5, 6, 7, 8, 9, 10, or more than 10 fluid device disassembly instruments. Additionally, or alternatively, in some variations, the fluid device disassembly instruments may include a plurality of disassembly actuators, such as 2, 3, 4, 5, 6, 7, 8, 9, 10, or more than 10 disassembly actuators per fluid device disassembly instrument. In such variations, fluid device disassembly instruments may additionally include a same number of transfer stages or may include fewer transfer stages than disassembly actuators. For example, in some variations, a fluid device disassembly instrument may include a single transfer stage configured to simultaneously couple to a plurality of fluid devices and simultaneously deliver each of the plurality of fluid devices to a corresponding disassembly actuator thereof.

FIGS. 13A-13C are renderings of a fluid device disassembly instrument 1300 and aspects thereof. FIG. 13A is a perspective view of the fluid device disassembly instrument 1300 including a portion 1301 of a fluid device (e.g., a container thereof), which may be secured to the transfer stage 1302. The transfer stage 1302 is disposed along first position actuator 1304, which may be a horizontal linear actuator configured to translate the transfer stage 1302 horizontally (i.e., along the x-axis indicated in FIG. 13A) toward (proximal to) and away from (distal to) the disassembly actuator 1310. The transfer stage 1302 is also coupled to a second position actuator 1306, which may be a vertical linear actuator configured to translate the transfer stage 1302 vertically (i.e., along the y-axis indicated in FIG. 13A) toward (proximal to) and away from (distal to) the disassembly actuator 1310. The disassembly actuator 1310 may include an opening 1312 shaped and sized to receive at least a portion of a fluid device (e.g., a collar thereof, or at least a portion of the collar) therein. During disassembly, disassembly actuator 1310 may be configured to apply a force to the fluid device therein to decouple a first portion (e.g., collar) of the fluid device from a second portion (e.g., container) of the fluid device. In some variations, the force applied by the disassembly actuator 1310 may be great enough to retain (e.g., at least temporarily, between about 0.1 seconds (s) and about 10 s, such as about 0.5 s and about 5 s, about 1 s and about 2.5 s, or about 1.5 s and about 2 s) the first portion of the fluid device therein after the second portion is released from the first portion. In some variations, the disassembly actuator 1310 may be actuated to transition from a tense (“disassembly”) configuration, during which force is applied within the opening 1312, to a relaxed (“at rest”) configuration. Further, each of the transfer stage 1302, first and second position actuators 1304, 1306, and disassembly actuator 1310 are integrated to form the disassembly instrument 1300 via frame 1308. The frame 1308 may be fabricated from a rigid or semi-rigid material such as a metal or a plastic. Further, the frame 1308 may include an outlet 1314 beneath the disassembly actuator 1310, where the outlet 1314 may have one or more dimensions (e.g., a length and/or a width) that are greater than one or more corresponding dimensions of a fluid device (or portion thereof, such as a collar). As such, the portion of the fluid device may be released from the disassembly actuator 1310 and through the outlet 1314 to be discarded. In some variations, a waste container (e.g., a biohazard waste container) configured to receive the removed portion of the fluid device may be positioned underneath the outlet 1314.

FIG. 13B is a perspective view of the transfer stage 1302. As shown, the transfer stage 1302 may include a sensor 1320 and locks 1322. The sensor 1320 may be a proximity sensor configured to detect a local presence of a fluid device. In some variations, the sensor 1320 may additionally be configured to detect when the fluid device has been disassembled by the disassembly actuator 1310. In some variations, the transfer stage 1302 may include a plurality of sensors, such as a plurality of proximity sensors, or a combination of proximity sensor(s), force sensor(s), and/or the like. The locks 1322 may be locking pins configured to be actuated to extend above an upper surface 1324 of the transfer stage 1302 and couple to complementary recesses on a container of the fluid transfer device. Further, the transfer stage 1302 may include a base 1326 and a raised portion 1328 extending upward therefrom. The raised portion 1328 may have dimensions that are about equal to or less than corresponding dimensions of an exterior bottom surface (e.g., underside) of the container. In some variations, the locks 1322 may be configured to apply a tension force to the container by coupling to and pulling against the container, therefore securing the container (and/or the entire fluid device) over the raised portion 1328 and onto the base 1326.

FIG. 13C is a perspective view of a portion of a fluid device 1301 (e.g., a container thereof) on the transfer stage 1302. In some variations, after the fluid device is disassembled, the transfer stage 1302, supporting only the portion of the fluid device 1301, may be configured to be repositioned (e.g., via one or both of the first a second position actuators 1304,1306) distally from the disassembly actuator 1310. The portion of the fluid device 1301 may generally include a fluid container 1330 that is exposed after the disassembly. In some variations, the fluid container 1330 may be configured to hold a volume of fluid of about 0.5 mL to about 50 mL, such as about 1 mL to about 40 mL, about 3 mL to about 30 mL, about 5 mL to about 20 mL, about 7 mL to about 15 mL, or about 9 mL to about 10 mL (including all ranges and subranges therebetween), such as about 10 mL. A fluid transfer device 1340 (e.g., a pipettor) of a fluid transfer system may be configured to transfer some or all of the fluid sample within the fluid container 1330 to the remainder of the fluid transfer system for sample preparation prior to analysis. In some variations, the fluid transfer device 1340 may be configured to transfer the fluid sample to at least one sample tube downstream.

Moreover, FIGS. 14A and 14B depict a top view and perspective view, respectively, of a fluid device disassembly instrument 1402 that is integrated with other components of a QC system 1400. As described above, the device transfer system 1404 may be configured to transfer a fluid device 1401 from the fluid device docking station 1406 to the disassembly instrument 1402. In some variations, the device transfer system 1404 may include device pads 1408 configured to support a fluid device along a conveyor 1407 of the device transfer system 1404. The device pads 1408 may have one or more dimensions (e.g., a length and/or width) that are about equal to or greater than corresponding dimensions of the fluid device 1401 such that the fluid device is not in contact with the conveyor 1407. In some variations, the conveyor 1407 may include an integrated data reader (not shown), such as a barcode scanner, for verifying a container type and tracking sample transfers within the QC system 1400. In some variations, the barcode may include data such as a cell product identification number and the tests (e.g., assays) required for the cell product. Moreover, in some variations, the device transfer system 1404 may be configured to transfer additional and/or alternative components of the QC system 1400 via the conveyor 1407. For example, one or more labware components, such as tube racks, well plates, etc., may be delivered into the QC system 1400 for storage or immediate use therein. The device transfer system 1404 may transfer a given labware component within the QC system 1400 via the conveyor 1407 (e.g., via a device pad 1408 thereof). Further, the labware component may include a barcode configured to be scanned by the data reader (not shown) so that the component may be transferred (e.g., via a robot) to the correct location.

In some variations, a robot (not shown) may be configured to transfer the fluid device 1401 from a proximal end 1405 of the device transfer system 1404 to the fluid device disassembly instrument 1402, such as to the transfer stage 1403 thereof. Additionally, the robot may be configured to remove a fluid device 1401 (or portion thereof, such as a container thereof) from the transfer stage 1403 (e.g., transfer the fluid device 1401 to a waste container) after the fluid transfer system 1420 has collected the fluid sample from therein. The fluid transfer system 1420 may include a liquid handler deck or pipette reservoir for obtaining and preparing fluid samples prior to analysis.

As discussed above with respect to FIG. 2, the QC systems herein may include one or more carts configured to store an instrument (or a plurality thereof) thereon. Cell processing instruments, such as analytical instruments within the QC systems herein, may require exchanging during high-throughput cell processing because each cell product includes unique processing and QC workflows, and thus various unique instruments. Additionally, analytical instruments may require maintenance or replacement during the lifetime of a QC system. The instrument carts described in more detail below may provide a flexible configuration for a QC system by providing a systematic approach for transitions related to instrumentation within the QC system and reducing the risk of errors or delays in the workflow.

Generally, the QC systems herein may include at least one cart enabling operators to efficiently remove and replace analytical instruments within the QC systems. In some cases, a QC system may include a cart system including a plurality of carts, such as 2, 3, 4, 5 or more than 5 carts. A QC system may include an instrument storage area (e.g., within an enclosure of the system) where one or more carts carrying backup analytical instruments may be stored, which may be accessible to an operator via a door. The carts herein may be mobile and configured to be moved from the instrument storage area to an external environment with ease. In some variations, the carts herein may include one or more handles to aid in steering the carts. Moreover, in some variations, the carts herein may include one or more fasteners, such as belts, straps, covers, drawers, and/or the like, to secure instruments on or within the carts. Similarly, the carts herein may include one or more mounts configured to allow the carts to be temporarily mounted to an interior or exterior wall of a QC system, and/or to another cart. In some variations, the carts herein may be fabricated from one or more strong and/or lightweight materials, such as one or more metals including, but not limited to, titanium, steel, aluminum, aluminum alloy, magnesium alloy, combinations thereof, and/or the like.

The carts herein may include one or more instrument support surfaces, each configured to carry one or more analytical instruments. In some variations, each instrument support surface of a cart may be configured to support about 0 kg to about 150 kg, such as about equal to or less than 150 kg, such as about equal to or less than 140 kg, about equal to or less than 130 kg, about equal to or less than 120 kg, about equal to or less than 110 kg, about equal to or less than 100 kg, about equal to or less than 90 kg, about equal to or less than 80 kg, about equal to or less than 70 kg, about equal to or less than 60 kg, about equal to or less than 50 kg, about equal to or less than 40 kg, about equal to or less than 30 kg, about equal to or less than 20 kg, about equal to or less than 15 kg, about equal to or less than 10 kg, or about equal to or less than 5 kg (including all ranges and subranges therein). In some variations, each instrument support surface of a cart may have a unique weight limit. For example, an uppermost instrument support surface may have a lower weight limit than one or more lower instrument support surfaces. In some variations, each instrument support surface may have a same weight limit.

In some variations, an instrument support surface, or a portion thereof, may be rotatable such that an instrument there on may be rotated with the surface. For example, an instrument support surface may include a turntable configured to be rotated at least about 45 degrees, at least about 90 degrees, at least about 135 degrees, at least about 180 degrees, at least about 225 degrees, at least about 270 degrees, at least about 315 degrees, or at least about 360 degrees. In some cases, a turntable may be configured to rotate about 45 degrees to about 360 degrees, such as about 90 degrees, about 135 degrees, about 180 degrees, about 225 degrees, about 270 degrees, about 315 degrees, or about 360 degrees. In some variations, a turntable may be configured to rotate unlimitedly. In some variations, a maximum rotation of a turntable may be adjustable. Further, an instrument support surface having a turntable may additionally include a lock to stabilize the surface and instrument thereon when rotation is not desired.

In some variations, a may include at least a first and a second instrument support surface. The first and second instrument support surfaces may be stacked such that the first instrument support surface is over and at least partially covering the second instrument support surface. In some variations, the first and second support surfaces may be a same shape, such as square, rectangular, triangular, circular, trapezoidal, or any other suitable shape. In some variations, the first and second instrument support surfaces may be different shapes. Additionally, or alternatively, the first instrument support surface may include one or more dimensions (e.g., length, width, height, perimeter, surface area, etc.) that are less than a corresponding dimension of the second instrument support surface smaller dimensions have the same dimensions (e.g., length, width, height, perimeter, surface area, etc.). A maximum length, width, or height of the first and second instrument support surfaces may be about 0.1 meters (m) to about 1.75 m, such as about 0.2 m to about 1.5 m, about 0.3 m to about 1 m, about 0.4 m to about 0.9 m, about 0.5 m to about 0.8 m, or about 0.6 m to about 0.7 m (including all ranges and subranges therebetween). In some variations, a maximum height of a cart may be about 0.5 m to about 2 m, such as about 0.6 m to about 1.75 m, about 0.7 m to about 1.5 m, about 0.8 m to about 1.25 m, or about 0.9 m to about 1 m (including all ranges and subranges therebetween). In some variations, one or more dimensions of the instrument support surface and/or cart (e.g., cart height) may be adjustable. For example, a frame of the cart may include a clip, a clamp, pins, or a ratcheting mechanism configured to be actuated (e.g., pressed) a first time such that a first portion of the frame may be moveable relative to a second, stationary portion of the frame, and may be actuated a second time (e.g., released) to maintain an adjusted position of the first portion of the frame relative to the second portion.

In some variations, a cart may include a plurality of wheels, such as 2, 3, 4, 5, 6, 7, 8, 9 10, or more than 10 wheels to facilitate mobility of the cart. In some variations, a wheeled cart may include one or more wheel locks, such as at least one wheel lock or one wheel lock per wheel, to provide stability when the cart is not mobile. Additionally, a cart may include a shock absorbing system to help stabilize the instrument support surfaces thereof, and thus the instruments thereon. The shock absorbing system may include casters, such as at least one caster per wheel, and/or may include rubber dampers, such as at least one damper per wheel. In some variations, the wheels of the carts themselves may be designed to absorb shock. For example, the wheels may be constructed of rubber or polyurethane.

Further, the carts herein may be designed to reduce or eliminate disruption to analytical instruments. Additionally, use of the carts herein may allow the QC systems herein to be expanded with new instruments (e.g., analytical instruments) and/or assays to customize workflows for cell products. In particular, the carts herein may include a base including one or more of a utility connection hub, a power supply module, and an integrated computer. The utility connection hub may include one or more of a power port, a gas port, and a network hookup port configured to couple with a corresponding utility port within a QC system. The utility connection hub may enable quick disconnection of the instruments of the cart from power, gas, and network connectors within the QC system (e.g., within the instrument storage area) and connection of the instruments to the utility connection hub so that the instruments remain powered during transfer operations. The power supply module may be configured to provide power to one or both of the second analytical instrument and the integrated computer. Moreover, the integrated computer may be instrument-specific and configured for use with fewer than all of the analytical instruments (e.g., with one analytical instrument) or may be instrument-agnostic. In some variations, the integrated computer may be replaced depending on which analytical instrument(s) a cart may be supporting.

FIGS. 15A and 15B are renderings of illustrative variations of a cart 1500 and a cart base 1550 (“base”), respectively. As shown in FIG. 15A, the cart 1500 may include a first instrument support surface 1502 and a second, lower instrument support surface 1504. The instrument support surfaces 1502, 1504 may be coupled via a frame 1506. The first instrument support surface 1502 may support a first analytical instrument 1512, which may have an optimal placement at a center of the first instrument support surface 1502 to lower the center of gravity of the cart 1500 and thus provide enhanced stability during instrument transfer with the cart 1500. Similarly, the second instrument support surface 1504 may support a second analytical instrument 1514, which may have an optimal placement about a center of the second instrument support surface 1504. Both the first and second instrument support surfaces 1502,1504 may include respective turntables 1516,1518. The cart 1500 may additionally include wheels 1510, each of which may be equipped with a wheel lock (not shown) and/or a shock absorber (not shown) to improve stability and control of the cart 1500 and reduce risk of damage to the first and second instruments 1512,1514 thereon. Further, the cart 1500 may include mountings 1508 for mounting the cart to a stable surface, such as a wall, as well as base 1530, which is described in more detail with respect to FIG. 15B below.

A transparent view of the base 1530 is depicted in FIG. 15B. As shown, the base 1530 includes a utility connection hub 1532, a power supply module 1534, and an integrated computer 1536. Also shown in FIG. 15B are the wheels 1510, each of which includes a shock absorber 1520, which may be a shock absorbing caster. Furthermore, FIG. 15B depicts another view of the second instrument support surface 1504 and its respective turntable 1518.

### B. METHODS

Described herein are also methods for performing automated QC workflows within the QC system.

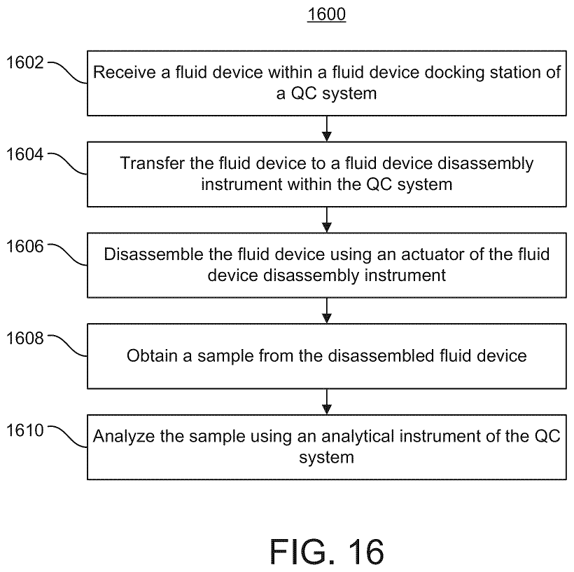

The methods herein may each describe transferring a fluid sample from a fluid device to QC system for analysis, such as via a fluid device of a fluid transfer system. In some variations, a fluid device may be manually disassembled, such that the fluid sample therein is exposed, upon loading a fluid device within a QC system (e.g., by docking the fluid device within a fluid device docking station). This manual disassembly may allow a fluid transfer system of the QC system to access and obtain some or all of the fluid sample when the fluid device is within the fluid device docking station. However, as described herein throughout, in some variations, a fluid device may be automatically disassembled within the QC system after docking. For example, a fluid device disassembly instrument may be configured to disassemble the fluid device without manual interference, which may support full automation and integration of the QC methods herein. Accordingly, briefly, a framework for automated QC workflows including automatic disassembly of a fluid device will be described with reference to method 1600 of FIG. 16. Some or all of the steps of the method 1600 may be used in conjunction with the other QC workflow methods herein.

Step 1602 of the method 1600 may include receiving a fluid device within a fluid device docking station of a QC system. Next, step 1604 may include transferring the fluid device to a fluid device disassembly instrument within the QC system. This step may occur automatically via one or both of a device transfer system and a robot within the QC system. Step 1606 of the method 1600 may include disassembling the fluid device using a disassembly actuator of the fluid device disassembly instrument. Steps 1604 and/or 1606 may also include securing the fluid device to a transfer stage of the fluid device disassembly instrument. Additionally, the disassembling step 1606 may include removing, via the fluid device disassembly instrument, a first portion of a fluid device from a second portion of the fluid device. The first portion of the fluid device may be a collar or cap, and the second portion may be a container housing the fluid sample. Removing the first portion from the second portion may expose the fluid sample to allow the subsequent fluid transfer step 1608—obtaining a sample from the disassembled fluid device (e.g., from a second portion or container portion of the fluid device) to occur (e.g., via the fluid transfer system). Finally, step 1610 of the method 1600 may include analyzing the sample obtained in step 1608 using an analytical instrument of the QC system. In some variations, a plurality of analytical instruments may be used to analyze the fluid sample.

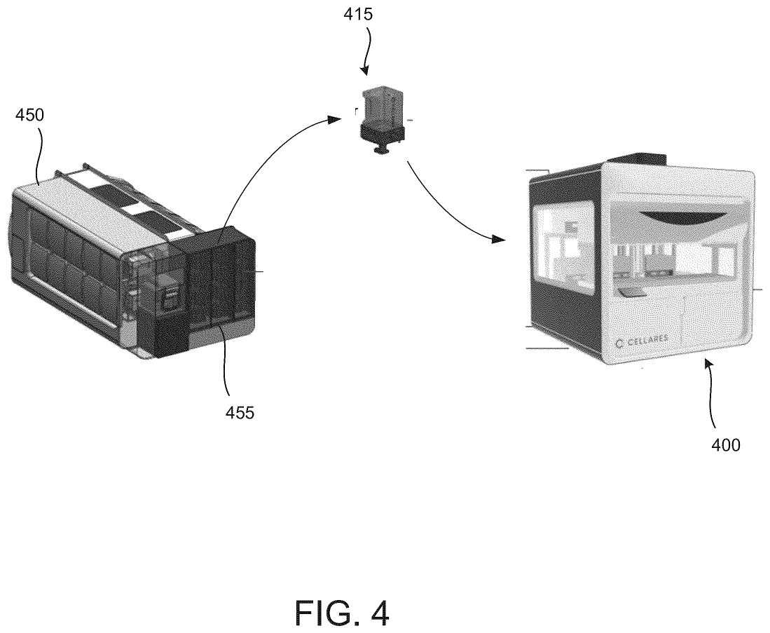

At a high-level, an aspect of a QC workflow is shown in the illustrative renderings of FIG. 4. The QC workflow may initially include receipt of a fluid device 415 from a cell processing system 450, the fluid device 415 comprising a fluid sample of an associated cell therapy product. In some variations, the fluid device 415 may be received from a reagent vault 455 of the cell processing system 450. The reagent vault 455 may be accessible directly by a user or may be accessible by a robot or other automated means so that the fluid device 415 may be transported to a QC system 400 without human intervention. Transporting the fluid device 415 to the QC system 400 may include docking the fluid device 415 within a fluid device docking station of the QC system 400.

This reflected in step 502 of method 500 shown in FIG. 5A, which is also depicted in FIG. 5B, where a fluid device 515 may be received within a fluid device docking station 501 of a QC system.

After docking, the fluid sample may be transferred from the fluid device 515 to a pipetting reservoir 516 at step 504. The fluid transfer from the fluid device 515 to the pipetting reservoir 516 may be aided by a connection formed between a sterile liquid transfer port of the fluid device 515 and a corresponding sterile liquid transfer port of the fluid device docking station 501, which may further be in fluidic communication with the pipetting reservoir 516 via e.g., tubing or other conduits. To this end, the fluid device docking station 501 may comprise controlling features for pumping fluid sample from the fluid device 515 into the pipetting reservoir 516.

In some variations, prior to step 504, the fluid device 515 may be transferred (e.g., via a device transfer system and/or a robot) to a fluid device disassembly instrument (e.g., fluid device disassembly instrument 303 of FIG. 3D) to access the fluid sample within the fluid device 515. Such a step may support the full automation of the QC methods herein by eliminating the need for an operator to disassemble the fluid device 151. In particular, a disassembling step may include removing, via the fluid device disassembly instrument, a first portion of a fluid device 515 from a second portion of the fluid device. The first portion of the fluid device 515 may be a collar or cap, and the second portion may be a container housing the fluid sample. Removing the first portion from the second portion may expose the fluid sample to allow the subsequent fluid transfer step 504 to occur.

Additional details regarding sterile liquid transfer ports, fluid transfer, and aspects thereof are provided e.g., in U.S. patent application Ser. No. 17/198,134, published as U.S. Patent Publication No. 2021/0283565, and entitled “Systems and Methods for Cell Processing U.S. patent application Ser. No. 18/620,826, entitled “Systems, Devices, and Methods for Fluid Transfer Within an Automated Cell Processing System”, and U.S. Provisional Patent Application No. 63/524,596, entitled “Systems, Devices, and Methods for Fluid Transfer Within an Automated Cell Processing System”, the contents of each which are incorporated by reference herein, the contents of each of which was previously incorporated by reference herein.

At step 506, fluid sample from the pipetting reservoir 516 may be transferred by a first fluid transfer device 511 of a fluid transfer system to a master well plate 513. In some variations, the first fluid transfer device 511 may be a 1-channel pipettor, a 8-channel pipettor, a 12-channel pipettor, or other appropriate multichannel pipettor. Each channel of the multichannel pipettor may be capable of transferring a known volume between about 0 μL and about 300 μL. The volume transferred may be dictated by a maximum fluid capacity of each well of the master well plate or by a volume required to perform prescribed analyses. Each channel of the multichannel pipettor may be capable of transferring a same volume or a different volume from neighboring channels of the multichannel pipettor. The master well plate 513 may be a multiwell plate, as described herein, and may be configured to receive aliquots from the fluid sample within the pipetting reservoir as well as other reagents, such as assay control samples, that may be needed. The other reagents, such as assay reagents and sample controls, may be provided by additional pipetting reservoirs. For example, the master well plate 513 may be a 96-well plate and may be configured to receive the fluid sample from the fluid device 515 into at least a portion of the wells of the 96-well plate. In some variations, the master well plate 513 may be configured to receive fluid samples from multiple fluid devices. For example, if a QC workflow determines that the same analytical tests are required for fluid samples from multiple fluid devices, wells of the master well plate 513 may be allocated to permit concurrent evaluation of the fluid samples from the multiple fluid devices. In another example, when a QC workflow determines that a subset of wells of the master well plate 513 is vacant, a fluid sample from another fluid device may be allocated to the subset regardless of which analytical tests are to be performed on the fluid sample and whether that is consistent with the other fluid samples already in the master well plate 513. This greatly improves throughput of the analysis. When the master well plate 513 receives fluid samples from multiple fluid devices, the allocation of the fluid samples within the master well plate 513 may be tracked on a per well basis. For example, when the master well plate 513 is a 96-well plate, columns 1-6 of row A may be allocated to fluid samples of a first fluid device while columns 7-12 of row A may be allocated to fluid samples of a second fluid device. In an example, a 96-well plate receives a fluid sample from 25 fluid devices, each fluid sample from the 25 fluid devices being replicated three times with the master well plate 513. Accordingly, the replicated fluid samples from the 25 fluid devices occupy 75 wells of the 96-well plate. The remaining wells may be used to contain assay specific controls or reagents. The spatial arrangement of the fluid samples may be tracked using the M-R data associated with each fluid device and the known structural layout of the master well plate 513.

At step 508, fluid sample aliquots may be transferred from the master well plate 513 to the at least one sample well plate 514. Each of the at least one sample well plate 514, such as Sample Well Plate A, Sample Well Plate B, Sample Well Plate C, and Sample Well Plate D, may be designated for a particular analytical instrument of the QC system. The fluid sample aliquot transfer from the master well plate 513 to the at least one sample well plate 514 may be performed by a second fluid transfer device 512 of the fluid transfer system. In some variations, the second fluid transfer device 512 may be a 1-channel pipettor, a 8-channel pipettor, a 12-channel pipettor, a 96-channel pipettor, other appropriate multichannel pipettor. Each channel of the multichannel pipettor may be capable of transferring a known volume between about 0 μL and about 300 μL. The volume transferred may be dictated by a particular analysis to be performed. Each channel of the multichannel pipettor may be capable of transferring a same volume or a different volume from neighboring channels of the multichannel pipettor. In some variations, the allocation and arrangement of the fluid sample, assay reagents, and assay controls within the master well plate 513 may be replicated in each of Sample Well Plate A, Sample Well Plate B, Sample Well Plate C, and Sample Well Plate D. In some variations, the allocation and arrangement of the fluid sample, assay reagents, and assay controls within each of Sample Well Plate A, Sample Well Plate B, Sample Well Plate C, and Sample Well Plate D is different from the master well plate 513. For example, appreciating that each sample well plate 514 may be designated for a different biological assay, the reagents and controls needed for a particular biological assay may dictate that different assay reagents, assay controls, and/or liquid volumes be used for each.

In some variations, steps 504, 506, and 508 form a closed-loop feedback system, wherein the amount of fluid sample transferred out of the fluid device 515 within the fluid device docking station 501 is controlled by the amount of fluid sample pipetted from the pipetting reservoir to the master well plate 516 by the first fluid transfer device 511. To this end, a pump module within the fluid device docking station 501 may be configured to interface with corresponding pumping features of the fluid device 515 and, informed by a known volume transferred to the pipetting reservoir 516 by the first fluid transfer device 511, to transport fluid out of the fluid device and into the pipetting reservoir. In one example, the volume transfer may be controlled by known flow rates and based on known volumes required for analyses. In another example, the volume transfer may be controlled based on sensors disposed proximate the master well plate and configured to detect a height of a fluid sample dispensed into each well of the master well plate. In an example, an optical sensor may be used to determine when a height of the fluid sample within a particular well has reached a threshold relative to a maximum height of the well. This closed system prevents unnecessary cell therapy product-associated fluid sample from being transferred out of the fluid device 5106.

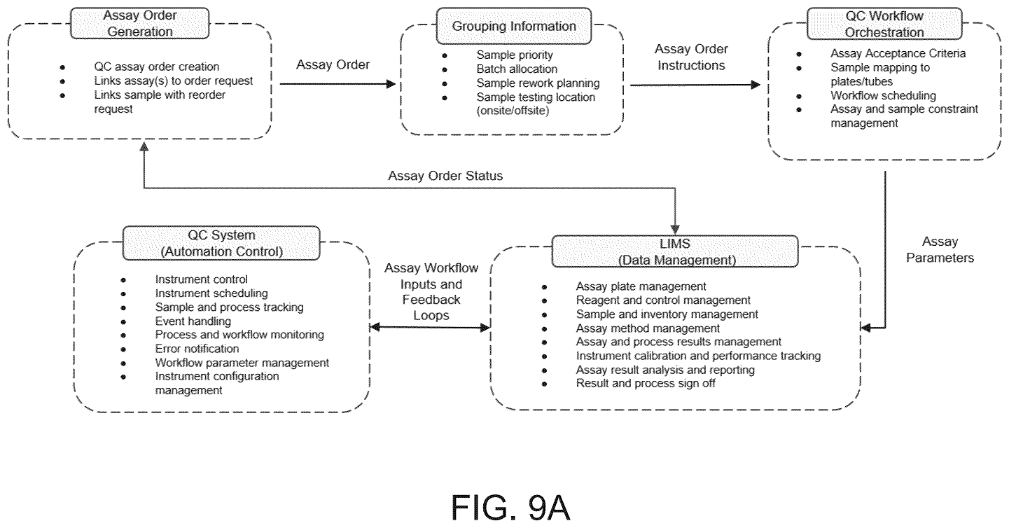

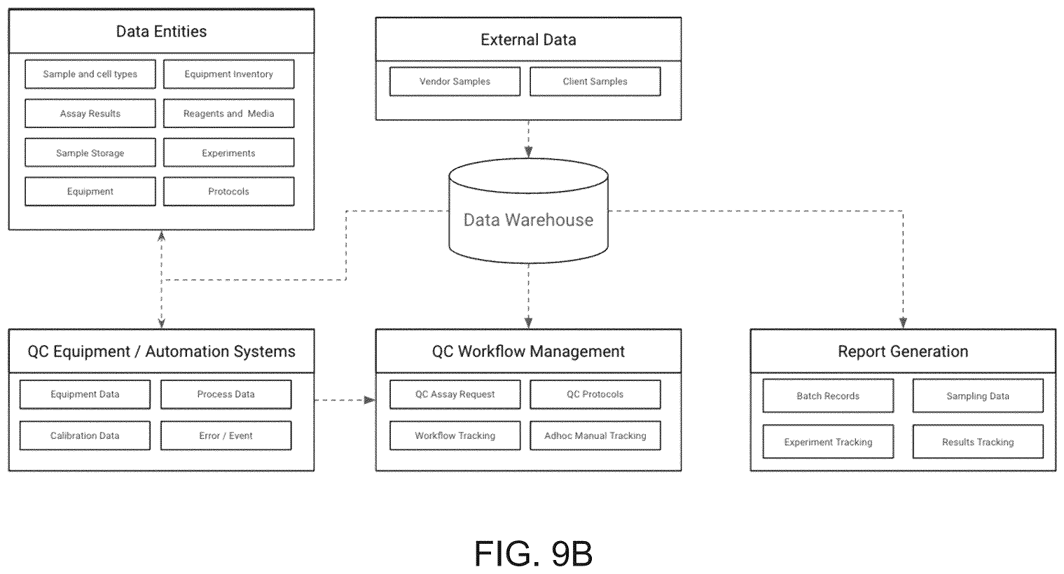

At step 510, each sample well plate 514 is moved to a corresponding analytical instrument by a robot, such as robot 302 of FIG. 3B, and a corresponding biological analysis is performed thereon. In some variations, each analytical instrument may be capable of performing a plurality of analyses. For example, the analytical instrument may be a flow cytometer capable of performing target cell percentage assays as well as quantitative subsets for e.g., lymphocytes such as T-cells, B-cells, and/or natural killer cells. In another example, the analytical instrument may be a quantitative thermocycler capable of performing human leukocyte antigen (HLA) typing, vesicular stomatitis virus G (VSV-G) copy number, viral safety analyses, and T-cell receptor knock out (TCR-KO)/chimeric antigen receptor knock in (CAR-KI) analyses. In another example, the analytical instrument may be a microplate reader capable of performing cytotoxicity and cytokine release studies. Thus, at step 510, the corresponding biological analysis may be only one of a plurality of biological analyses the corresponding analytical instrument is capable of performing. Following step 510, data output from each analytical instrument may be evaluated in view of cell therapy product acceptance criteria. In other words, data management tools, such as those shown in FIG. 9A and FIG. 9B, collect QC workflow data and analyze results for the purpose of generating quality control reports and analyses. This evaluation may help to determine whether the cell therapy product associated with the fluid sample may be released for patient use. Generally, these acceptance criteria are specific to particular biological analyses performed and/or particular cell therapy products being evaluated. Examples of acceptance criteria include thresholds regarding cell count, percentage T-cell population, detection of a contamination source, and/or may also include a pre-defined range of collective measurements. For example, the acceptance criteria may include, among others, cell viability (i.e., if the assay data is below 90% cell viability, the assay may not be released). In another example, the acceptance criteria may include, among others, a percentage of a population that is a CAR-T cell (i.e., if the assay data is below a certain percentage threshold CAR-T cell, the assay may not be released).

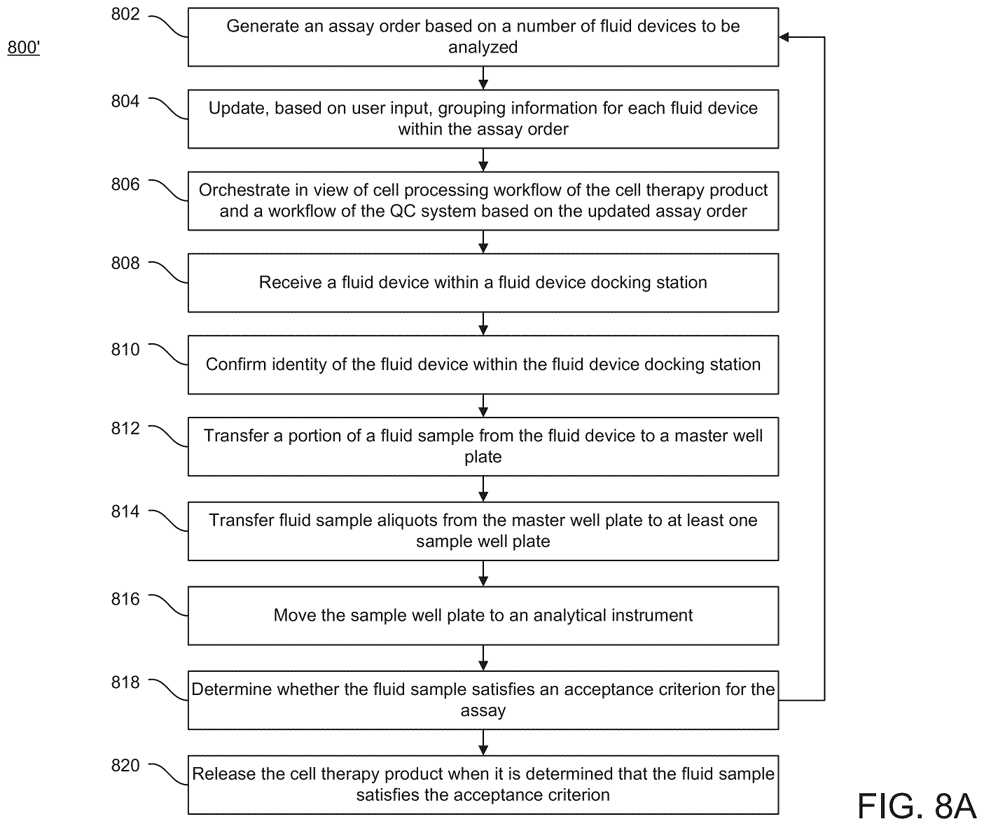

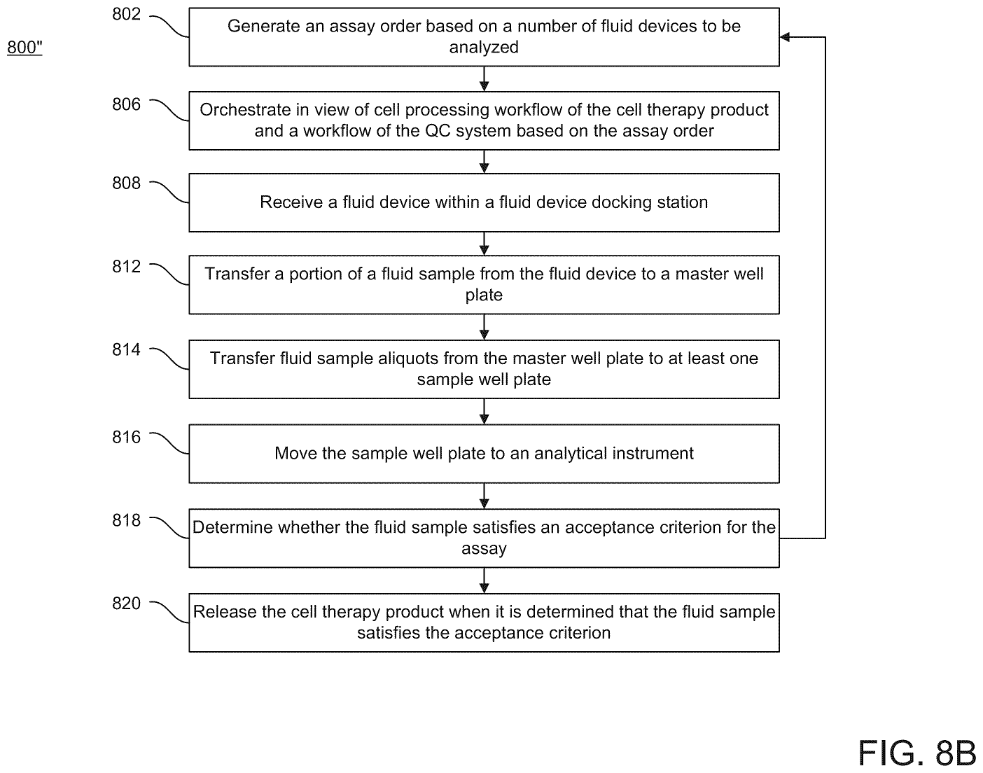

In some variations, as noted above, the acceptance criteria are specific to a particular biological analysis being performed and/or to a specific cell therapy product being developed. For example, certain biological analyses will have higher or lower acceptance ranges. In another example, as may be appreciated by one of ordinary skill in the art, each cell therapy product may be associated with a unique set of acceptance criterion. In some variations, the acceptance criteria include multiple criterion and the cell therapy product associated with the fluid sample may be released for patient use when all of the acceptance criteria are satisfied. In some variations, when the acceptance criteria include multiple criterion, the cell therapy product associated with the fluid sample may be released for patient use when at least one of the criterion are satisfied, when a certain number of criterion are satisfied, when a majority of the criterion are satisfied, or when all criterion are satisfied. Determinations regarding whether an output of each one of the analytical instruments meets a predetermined acceptance criterion, or predetermined acceptance criteria, for each cell therapy product will be discussed more with reference to FIG. 8A.

Referring now to FIG. 6, another illustrative QC workflow is shown with reference to phases of the QC workflow, including QC system inputs 682, QC system fluid handling 684, and QC system analysis 686.

In some variations, the QC system inputs 682 include fluid device(s) 615, reagents 654, and labware 644. Fluid sample from the fluid device(s) 615, as previously described, may be transferred to pipetting reservoir 616 of a QC system 600 via a fluid device docking station of the QC system 600. In some variations, either automatically or manually, the reagents 654, as previously described, may be provided to a reagent storage compartment 635 of a QC system 600 and the labware 644, which may include pipette tips, multiwell plates, and pipetting reservoirs, as previously described, may be provided to the labware storage compartment 645. In some variations, the reagents 654 and the labware 644 may be previously loaded within the reagent storage compartment 635 and the labware storage compartment 645 of the QC system 600.

In some variations, QC system fluid handling 684 may include performing a first fluid transfer by a first fluid transfer device 611 and at least one second fluid transfer by a second fluid transfer device 612, one of which may be referred to as an intermediate fluid transfer. For example, in the event an intermediate multiwell plate is needed between a master well plate and at least one sample well plate, more than one second fluid transfer may be performed. Throughout QC system fluid handling 684, however, QC system fluid handling 684 may include retrieving, by a robot of the QC system 600, needed reagents from the reagent storage compartment 635 and needed labware, such as multiwell plates and pipetting reservoirs, from the labware storage compartment 645.

In some variations, the intermediate fluid transfer, in addition to the second fluid transfer, is required in order to perform specific fluid sample preparations for particular downstream analytical instruments. For example, the intermediate fluid transfer may be required to perform fluid sample preparations for flow cytometry, cell counting, qPCR, Luminex, enzyme-linked immunosorbent assays, and/or fluorescence assays. In an example, for assays that require the isolation of materials, such as DNA, for use in a final readout step, an intermediate fluid transfer and an “intermediate” sample well plate are used to perform particular prerequisite method steps before the second fluid transfer to a second sample assay plate and assay readout.

After preparation at the intermediate fluid transfer, fluid sample aliquots may be transferred to the second sample assay plate for delivery to a particular analytical instrument. The analytical instrument may be, for example, one or more of a flow cytometer, a cell counter, a quantitative thermocycler (e.g., qPCR), a fluorimeter, a flow-based bead reader (e.g., multiplex immunoassays), polymerase chain reaction systems (e.g., digital polymerase chain reaction or “dPCR”), cell analyzers, an incubator, a plate reader (e.g., a microplate reader), and a Luminex device. To this end, QC system analysis 686 includes transferring, by the robot of the QC system 600, the at least one sample well plate to a corresponding one of the Analytical Instrument A 605A, Analytical Instrument B 605B, Analytical Instrument C 605C, Analytical Instrument D 605D, and Analytical Instrument E 605E.

In some embodiments, and when multiple fluid devices contribute fluid samples to a single master well plate, a user may be instructed to introduce particular fluid devices to the fluid device docking station of the QC system in a particular order according to a QC workflow. When this sequential order is followed, the QC system may readily transfer the fluid from the fluid device to a pipetting reservoir and then into a master well plate according to a prescribed allocation and arrangement of fluid sample aliquots. As such, the allocation of known fluid samples may be tracked through the QC workflow. However, even in the event a user introduces the fluid devices to the fluid device docking station out of order, the QC system may ensure that the fluid sample aliquots are delivered to the correct locations within the master well plate based on M-R data associated with the fluid device. FIG. 7 is a flow diagram depicting this method.

At step 702 of method 700, a first fluid device is received within a fluid device docking station of the QC system. The first fluid device may be any one of a plurality of fluid devices identified within a QC workflow as intended for inclusion on a current master well plate.

Next, at step 704 of method 700, an identity of a fluid sample contained within each fluid device may be determined according to fluid sample data derivable from the fluid device. As described above with reference to FIG. 3C, each of the plurality of fluid devices, including the first fluid device, may comprise machine readable data that may be interpreted by a data reader of the fluid device docking station to obtain fluid sample data, including a sample-ID, sample volume, and the like. Thus, regardless of the order in which the plurality of fluid devices is introduced to the fluid device docking station, a corresponding fluid sample may be aliquoted into wells of the current master well plate in accordance with the prescribed QC workflow.

To this end, at step 706 of method 700, the fluid sample may be transferred from the first fluid device to the current master well plate via the pipetting reservoir. As described previously, control of the fluid sample transfer from the first fluid device into the current master well plate may be based on a volume of the fluid sample required to be introduced to the corresponding wells of the current master well plate and the fluid capacity of each well.

Steps 702, 704, and 706 are shown within a dashed box because they may be performed iteratively until each fluid device of the plurality of fluid devices identified within the QC workflow have been introduced to the fluid device docking station.

In some variations, prior to step 706, the fluid device(s) may be transferred to a fluid device disassembly instrument (e.g., fluid device disassembly instrument 303 of FIG. 3D) to disassemble the fluid device. Such a step may support the full automation of the QC methods herein by eliminating the need for an operator to disassemble the fluid device(s). In particular, a disassembling step may include removing, via the fluid device disassembly instrument, a first portion of a fluid device from a second portion of the fluid device. The first portion of the fluid device may be a collar or cap, and the second portion may be a container housing the fluid sample. Removing the first portion from the second portion may expose the fluid sample to allow the subsequent fluid transfer step 706 to occur.

After fluid samples from the plurality of fluid devices have been transferred to the master well plate, reagents and control samples for each analytical test identified in the QC workflow may be added to remaining empty wells of the master well plate. Such reagents may include substances or mixtures for use in analytical assays. For example, in addition to those previously described herein, the reagents may include buffer, dyes, antibodies, purified proteins, and small molecules. Control samples, which may include positive and negative control samples, are used to ensure the assay is properly run and are used to determine whether results are within a specified range. The controls may also be used to replicate a fluid sample result, thereby determining assay accuracy and sensitivity. As with assay reagents, control samples may be specified by a particular assay and analysis result type.

After transferring fluid sample from each of the plurality of fluid devices into corresponding wells of the master well plate, aliquots of the fluid samples, reagents, and controls may be transferred at step 707 to at least one sample well plate based on the fluid sample data associated with each fluid device and a corresponding analytical test identified with the QC workflow for each fluid device. Each of the at least one sample well plate may be designated for one of the corresponding analytical tests. Any additional preparation required for respective analytical testing may be performed immediately after fluid sample aliquoting into the at least one sample well plate.

After each of the at least one sample well plates are prepared for evaluation, each may be moved to a respective analytical instrument at step 708 of method 700. Each of the at least one sample well plates may be moved by a robot, such as robot 302 of FIG. 3B, and a corresponding biological analysis may be performed thereon.

Following step 708, data output from each analytical instrument may be evaluated in view of cell therapy product acceptance criteria. In other words, data management tools, such as those shown in FIG. 9A and FIG. 9B, may collect QC workflow data and analyze results for the purpose of generating quality control reports and analyses. This evaluation may help to determine whether the cell therapy product associated with the fluid sample may be released for patient use. Generally, these acceptance criteria are specific to particular biological analyses performed and/or particular cell therapy products being evaluated. Examples of acceptance criteria include thresholds regarding cell count, percentage T-cell population, detection of a contamination source, and/or may also include a pre-defined range of collective measurements. For example, the acceptance criteria may include, among others, cell viability (i.e., if the assay data is below 90% viability, the assay may not be released). In another example, the acceptance criteria may include, among others, a percentage of a population that is a CAR-T cell (i.e., if the assay data is below a certain percentage threshold CAR-T cell, the assay may not be released).

In some variations, as noted above, the acceptance criteria may be specific to a particular biological analysis being performed and/or to a specific cell therapy product being developed. For example, certain biological analyses will have higher or lower acceptance ranges. In another example, as may be appreciated by one of ordinary skill in the art, each cell therapy product may be associated with a unique set of acceptance criterion. In some variations, the acceptance criteria include multiple criterion and the cell therapy product associated with the fluid sample may be released for patient use when all of the acceptance criteria are satisfied. In some variations, when the acceptance criteria include multiple criterion, the cell therapy product associated with the fluid sample may be released for patient use when at least one of the criterion are satisfied, when a certain number of criterion are satisfied, when a majority of criterion are satisfied, or when all criterion are satisfied. Determinations regarding whether an output of each one of the analytical instruments meets a predetermined acceptance criterion, or predetermined acceptance criteria, for each cell therapy product will be discussed more with reference to FIG. 8A.

Essential to the QC workflow methods described above is the ability to orchestrate said QC workflows. In fact, seamless, automated operation of the QC system requires real-time decision-making of the management of process step parameters, sample testing prioritization, and assay result acceptance criteria within a given QC workflow. Thus, as described with reference to FIG. 8A and FIG. 8B, a QC workflow management system may be implemented to set up, perform, and monitor a defined sequence of automated QC workflow process steps, arranged as a workflow application, which may update in real time based on workflow events or external data inputs.

To this end, FIG. 8A is a flow diagram of a method 800′ for orchestration of a QC workflow resulting in a determination of whether a cell therapy product associated with a fluid sample should be released for patient use. It should be appreciated that method 800′ may be performed by a controller of the QC system, such as a controller 220 of FIG. 2, in view of user input, workflow events, and/or external data inputs and the like.

First, at step 802 of method 800′, an assay order may be generated based on a number of fluid samples to be analyzed. The number of fluid samples to be analyzed may be based on data received from one or more cell processing systems indicating a number of cell therapy products completed or nearing completion (which will need to be evaluated by the QC system prior to release) and a type of the cell therapy products completed or nearing completion. Fluid devices containing the fluid samples associated with the cell therapy products, or aliquots thereof, may be stored within a reagent vault of the cell processing system, such as reagent vault 455 shown in FIG. 4, prior to evaluation within the QC system. Each of the fluid devices and an identity of the fluid samples therein may be associated and this pairing may be encoded within machine readable data disposed on or within each fluid device (as discussed with reference to FIG. 3C).

In some variations, the assay order may be a pre-ordered list of fluid devices to be delivered to the QC system. The pre-ordered list may be based chronologically on a time of completion of the cell therapy products awaiting testing. In some variations, the assay order may be randomly determined. In some variations, the assay order may be based on standardized or pre-determined grouping information. The standardized or pre-determined grouping information may include prioritization data reflective of e.g., a known importance of a particular fluid sample-associated cell therapy product. The prioritization data may be based on a type of cell therapy product to be evaluated, atypical turnaround time for evaluation of the cell therapy product, types of evaluations to be performed on the cell therapy product, an indication of timing sensitivity of importance of the cell therapy product, a location of the fluid sample testing (e.g., within the QC system or offsite), and the like. For example, analyses that require a longer runtime, and thus lower user input, may be grouped together at the end of a daily QC workflow to exploit the overnight waiting period. Analyses that require the same analytical instrument to be performed, such as an ELISA and fluorescence-based assays, may be chronologically separated to avoid confrontations (assuming only one microplate reader is available with the QC system).

At step 804 of method 800′, the controller may receive input from a user regarding the assay order. For example, the user input may include updates to the grouping information for each fluid device within the assay order. As above, the grouping information may include prioritization data. However, at step 804, the controller may receive user input regarding the prioritization data, which may further qualify fluid sample priority based on a type of cell therapy product to be evaluated, types of evaluations to be performed on the cell therapy product, an indication of timing sensitivity of importance of the cell therapy product, and the like. For example, certain fluid devices, and cell therapy product-associated fluid samples therein, may be assigned higher priority or lower priority. Accordingly, based on the user input, the controller may generate updated grouping information for each fluid device within the assay order at step 804 of method 800′.

At step 806 of method 800′, the controller may orchestrate a QC workflow for the fluid devices based on the updated grouping information and a cell processing workflow of each of the fluid devices. For example, the controller may consider whether each fluid device is completed or is nearing completion within a cell processing workflow (of a cell processing system) when determining where in an assay order the fluid device should be temporally arranged. Primarily, the QC workflow will be orchestrated based on the updated assay order, reflecting the updated grouping information, and based on availability of reagents (assay reagents and control samples) and analytical instruments. In this way, the QC workflow may be designed in order to increase throughput and decrease turnaround times, mapping the availability of reagents and analytical instruments with desired turnaround time.

At step 808 of method 800′, based on the QC workflow orchestrated at step 806, which includes a schedule of events for the QC workflow (e.g., a first fluid device should be delivered at a particular start time and should be removed at a particular stop time), a first fluid device may be received within a fluid device docking station of the QC system. The first fluid device may be a first fluid device within the schedule of events for the QC workflow and may be delivered to the QC system by an automated means (e.g., wheeled robot) or by a user.

In some variations, an identity of the fluid device is confirmed at step 810 of method 800′ by a data reader of the fluid device docking station. Specifically, the data reader of the fluid device docking station may be configured to read machine-readable data disposed on the fluid device and determine an identity of the fluid device based on data encoded within the machine-readable data.

Assuming the identity of the fluid device matches an expected fluid device identity, or, alternatively, that the identity of the fluid device matches an identity of a fluid device prescribed to be evaluated within the current master well plate, a portion of the fluid sample within the fluid device may be transferred, by a first fluid transfer device, from the fluid device to the current master well plate via a pipetting reservoir at step 812 of method 800′.

In some variations, the fluid transfer process of step 812 of method 800′, described previously with respect to FIGS. 5A-7, may be a closed-loop feedback process, wherein an amount of fluid sample transferred from the fluid device to the current master well plate via the pipetting reservoir is based on a volume of fluid sample detected within a pipetting reservoir and/or within wells of the current master well plate. In an example, the fluid transfer system of the QC system, within which the pipetting reservoir resides, may be outfitted with optical sensors, at least one load cell, or force sensors to determine a mass of volume transferred from the fluid device to the pipetting reservoir. When the mass transferred is out of an expected range of transferred fluid (e.g., not enough fluid has been transferred), the QC system may generate an alert to rectify the error (e.g., transfer more fluid). Accordingly, when the mass transferred is within the expected range of transferred fluid, the fluid transfer may be stopped. In another example, the fluid transfer system of the QC system, within which the current master well plate resides, may be outfitted with optical sensors, to detect a fluid level within each well of the current master well plate. Accordingly, when the fluid level reaches a threshold relative to a height of each well of the current master well plate, the fluid transfer may be stopped. Of course, other methods for detection of transferred fluid volumes may be used, such as flow rate-based measures and the like.

Steps 808, 810, and 812 may be performed iteratively based on the orchestrated QC workflow until each well within the current master well plate is filled. Of course, the orchestrated QC workflow may dictate that certain wells remain empty such that the fluid transfer system may fill them with reagents (e.g., assay reagents, assay control samples) appropriate for the analytical tests prescribed for the fluid samples under test.

At step 814 of method 800′, and after the current master well plate has been filed, a second fluid transfer device may transfer fluid sample aliquots from the current master well plate to at least one sample well plate, in accordance with a number and type of analytical tests to be performed on the fluid samples. As described with reference to FIG. 6, such transfer may be performed to prepare the fluid samples for particular assays. To this end, the second fluid transfer device may be configured to additionally transfer fluid sample aliquots to intermediate sample well plates prior to transfer to the at least one “final” sample well plate.

At step 816 of method 800′, the controller may instruct a robot within the QC system to move the at least one sample well plate from the fluid transfer device to corresponding ones of the analytical instruments.

After the analytical instruments perform their evaluations, the controller may determine at step 818 of method 800′ whether each fluid sample on the at least one sample well plate satisfies acceptance criteria for the particular assay and, therefore, is ready to be released for patient use. Generally, these acceptance criteria are specific to particular biological analyses performed and/or particular cell therapy products being evaluated. Examples of acceptance criteria include thresholds regarding cell count, percentage T-cell population, detection of a contamination source, and/or may also include a pre-defined range of collective measurements. For example, the acceptance criteria may include, among others, cell viability (i.e., if the assay data is below 90% viability, the assay may not be released). In another example, the acceptance criteria may include, among others, a percentage of a population that is a CAR-T cell (i.e., if the assay data is below a certain percentage threshold CAR-T cell, the assay may not be released). In some variations, the acceptance criteria may include an acceptable percentage of cells within a population having a particular cell surface marker.

In some variations, as noted above, the acceptance criteria are specific to a particular biological analysis being performed and/or to a specific cell therapy product being developed. For example, certain biological analyses will have higher or lower acceptance ranges. In another example, as may be appreciated by one of ordinary skill in the art, each cell therapy product may be associated with a unique set of acceptance criterion. In some variations, the acceptance criteria include multiple criterion and the cell therapy product associated with the fluid sample may be released for patient use when all of the acceptance criteria are satisfied. In some variations, when the acceptance criteria include multiple criterion, the cell therapy product associated with the fluid sample may be released for patient use when at least one of the criterion are satisfied.

If it is determined at step 818 of method 800′ that a fluid sample has not satisfied the acceptance criteria, or has not satisfied an acceptance criterion, the fluid sample is re-inserted into the QC workflow during assay order generation at step 802 and re-orchestration is performed. This is possible because the originally transferred fluid sample includes extra fluid sample for possible re-testing. If a second, a third, a fourth, or more evaluation of the particular fluid sample continues to fail to meet the acceptance criteria, the corresponding cell therapy product may be marked as unusable. Alternatively, in certain cases, QC workflow re-orchestration may coordinate method recovery parameters to restart and transfer a particular assay to a manual workflow to salvage sample result generation.

If it is determined at step 818 of method 800′ that a fluid sample has satisfied the acceptance criteria, method 800′ proceeds to step 820 and the cell therapy product associated with the fluid sample may be released for use in a patient.

FIG. 8B is a variation of method 800′ wherein the grouping information is determined without user input in real time and a QC workflow is orchestrated on this basis. As with method 800′, it should be appreciated that method 800″ may be performed by a controller of the QC system, such as a controller 220 of FIG. 2, in view of workflow events and/or external data inputs and the like.

First, at step 802 of method 800″, an assay order may be generated based on a number of fluid samples to be analyzed. The number of fluid samples to be analyzed may be based on data received from one or more cell processing systems indicating a number of cell therapy products completed or nearing completion (which will need to be evaluated by the QC system prior to release) and a type of the cell therapy products completed or nearing completion. Fluid devices containing the fluid samples associated with the cell therapy products, or aliquots thereof, may be stored within a reagent vault of the cell processing system, such as reagent vault 455 shown in FIG. 4, prior to evaluation within the QC system. Each of the fluid devices and an identity of the fluid samples therein may be associated and this pairing may be stored within a server to be used by the controller when orchestrating the QC workflow.

In some variations, the assay order may be a pre-ordered list of fluid devices to be delivered to the QC system. The pre-ordered list may be based chronologically on a time of completion of the cell therapy products awaiting testing. In some variations, the assay order may be randomly determined. In some variations, the assay order may be based on standardized or pre-determined grouping information. The standardized or pre-determined grouping information may include prioritization data reflective of e.g., a known importance of a particular fluid sample associated cell therapy product. The prioritization data may be based on a type of cell therapy product to be evaluated, atypical turnaround time for evaluation of the cell therapy product, types of evaluations to be performed on the cell therapy product, an indication of timing sensitivity of importance of the cell therapy product, a location of the fluid sample testing (e.g., within the QC system or offsite), and the like. For example, analyses that require a longer runtime, and thus lower user input, may be grouped together at the end of a daily QC workflow to exploit the overnight waiting period. Analyses that require the same analytical instrument to be performed, such as an ELISA and fluorescence-based assays, may be chronologically separated to avoid confrontations (assuming only one microplate reader is available with the QC system).

At step 806 of method 800″, the controller may orchestrate a QC workflow for the fluid devices based on the grouping information and a cell processing workflow of each of the fluid devices. For example, the controller may consider whether each fluid device is completed or is nearing completion within a cell processing workflow (of a cell processing system) when determining where in assay order the fluid device should be temporally arranged. Primarily, the QC workflow will be orchestrated based on the grouping information and on availability of reagents (assay reagents and control samples) and analytical instruments. In this way, the QC workflow may be designed in order to increase throughput and decrease turnaround times, mapping the availability of reagents and analytical instruments with desired turnaround time.

At step 808 of method 800″, based on the QC workflow orchestrated at step 806, which includes a schedule of events for the QC workflow, a first fluid device may be received within a fluid device docking station of the QC system. The first fluid device may be a first fluid device within the schedule of events for the QC workflow and may be delivered to the QC system by an automated means (e.g., wheeled robot) or by a user. Notably, unlike method 800′, fluid devices in method 800″ are delivered as dictated by the orchestrated QC workflow and as expected by the QC system.

After docking within the fluid device docking station, a portion of the fluid sample within the fluid device may be transferred, by a first fluid transfer device, from the fluid device to the current master well plate via a pipetting reservoir at step 812 of method 800″.

In some variations, the fluid transfer process of step 812 of method 800″, described previously with respect to FIGS. 5A-7, may be a closed-loop feedback process, wherein an amount of fluid sample transferred from the fluid device to the current master well plate via the pipetting reservoir is based on a volume of fluid sample detected within wells of the current master well plate. In an example, the fluid transfer system of the QC system, within which the current master well plate resides, may be outfitted with optical sensors, to detect a fluid level within each well of the current master well plate. Accordingly, when the fluid level reaches a threshold relative to a height of each well of the current master well plate, the fluid transfer may be stopped. Of course, other methods for detection of transferred fluid volumes may be used, such as weight-based measures, flow rate-based measures, and the like.

Steps 808 and 812 may be performed iteratively based on the orchestrated QC workflow until each well within the current master well plate is filled. Of course, the orchestrated QC workflow may dictate that certain wells remain empty such that the fluid transfer system may fill them with reagents (e.g., assay reagents, assay control samples) appropriate for the analytical tests prescribed for the fluid samples under test.

At step 814 of method 800″, and after the current master well plate has been filed, a second fluid transfer device may transfer fluid sample aliquots from the current master well plate to at least one sample well plate, in accordance with a number and type of analytical tests to be performed on the fluid samples. As described with reference to FIG. 6, such transfer may be performed to prepare the fluid samples for particular assays. To this end, the second fluid transfer device may be configured to additionally transfer fluid sample aliquots to intermediate sample well plates prior to transfer to the at least one “final” sample well plate.

At step 816 of method 800″, the controller may instruct a robot within the QC system to move the at least one sample well plate from the fluid transfer device to corresponding ones of the analytical instruments.

After the analytical instruments perform their evaluations, the controller may determine at step 818 of method 800″ whether each fluid sample on the at least one sample well plate satisfies acceptance criteria for the particular assay and, therefore, is ready to be released for patient use. Generally, these acceptance criteria are specific to particular biological analyses performed and/or particular cell therapy products being evaluated. Examples of acceptance criteria include thresholds regarding cell count, percentage T-cell population, detection of a contamination source, and/or may also include a pre-defined range of collective measurements. For example, the acceptance criteria may include, among others, cell viability (i.e., if the assay data is below 90% viability, the assay may not be released). In another example, the acceptance criteria may include, among others, a percentage of a population that is a CAR-T cell (i.e., if the assay data is below a certain percentage threshold CAR-T cell, the assay may not be released). In some variations, the acceptance criteria may include an acceptable percentage of cells within a population having a particular cell surface marker.

In some variations, as noted above, the acceptance criteria are specific to a particular biological analysis being performed and/or to a specific cell therapy product being developed. For example, certain biological analyses will have higher or lower acceptance ranges. In another example, as may be appreciated by one of ordinary skill in the art, each cell therapy product may be associated with a unique set of acceptance criterion. In some variations, the acceptance criteria include multiple criterion and the cell therapy product associated with the fluid sample may be released for patient use when all of the acceptance criteria are satisfied. In some variations, when the acceptance criteria include multiple criterion, the cell therapy product associated with the fluid sample may be released for patient use when at least one of the criterion are satisfied.

If it is determined at step 818 of method 800″ that a fluid sample has not satisfied the acceptance criteria, or has not satisfied an acceptance criterion, the fluid sample is re-inserted into the QC workflow during assay order generation at step 802 and re-orchestration is performed. This is possible because the originally transferred fluid sample includes extra fluid sample for possible re-testing. If a second, a third, a fourth, or more evaluation of the particular fluid sample continues to fail to meet the acceptance criteria, the corresponding cell therapy product may be marked as unusable. Alternatively, in certain cases, QC workflow re-orchestration may coordinate method recovery parameters to restart and transfer a particular assay to a manual workflow to salvage sample result generation.

If it is determined at step 818 of method 800″ that a fluid sample has satisfied the acceptance criteria, method 800″ proceeds to step 820 and the cell therapy product associated with the fluid sample may be released for use in a patient.

As described with reference to FIG. 8A and FIG. 8B, incorporating end-to-end automation and data and workflow management infrastructure for in-process and release QC testing provides significant advantages over traditional manual QC testing workflows. Modeling of the process timing steps, sample capacity, and turnaround time on assay results yield up to a 90% decrease in labor and operating costs.

In view of the flow diagrams described above, enabling the full capabilities of the QC system requires the integration of QC workflow orchestration, scheduling, and workflow management tools to enable seamless operations. To this end, FIGS. 9A and 9B provide low-level diagrams of data management within the QC system and relative to QC workflows.

FIG. 9A is a diagram demonstrating how assay orders are translated from high-level assay instructions to low-level process and assay data parameters. As shown in FIG. 9A, an assay order may initially be generated based on data within a data management server (“LIMS”). The assay order may be automatically generated or may be generated by a user. The grouping information for each fluid sample within the generated assay order may then be determined and a QC workflow may be orchestrated on this basis. To this end, assuming that multiple orders associated with multiple fluid samples are received concurrently, the prioritization of the samples (including grouping) may be exploited to orchestrate the QC workflow. Specifically, the orchestration may include mapping where each fluid sample should be allocated, what consumables are needed for each biological assay, timing coordination, and providing acceptance criteria for each fluid sample, among others. The LIMS may then be updated based on the QC workflow orchestration and the QC system automation control may be engaged to control performance of the QC workflow. To this end, the LIMS may consider all parameters, assign them to specific locations (e.g., the LIMS has all the stored information and is generating new information to allow the biological assays to be run), and the QC workflow may be executed based on this schedule and sample. QC workflow orchestration sets a schedule for when a fluid sample batch needs to start and to end, thereby maximizing workflow efficiency. Similarly, QC workflow orchestration may reset, based on updated grouping information, a QC workflow schedule of events when a particular quality control request needs to be fast tracked through the QC system for a fast turn-around. In certain cases, QC workflow orchestration may coordinate method recovery parameters to restart and transfer a particular assay to a manual workflow to salvage sample result generation. However, in other cases, QC workflow orchestration coordinates updated assay orders for samples that require assay retesting. For example, appreciating that the LIMS and the QC system are in communication throughout, the LIMS may receive results and then provide this information (i.e., “Assay Order Status”) back to be considered during assay order generation. LIMS may inform the status of each assay order (e.g., if the assay order fails to be executed due to a system issue), and it may be determined that the sample should be re-run during assay order generation. This orchestration advantageously saves operators significant time as there is limited to no manual moving of data, data analysis, or final assay report generation. Moreover, QC workflow orchestration may track each fluid sample transfer and each associated processing step within the QC system to allow for real-time status reporting and end-to-end traceability of fluid samples.

In some variations, QC workflow orchestration as shown in FIG. 9A may deploy a scheduler to perform high- and low-level scheduling of assay requests, QC system tasks, and analytical instrument resources.

In some variations, an assay order may include acceptance criteria for associated fluid samples within the assay order.

In some variations, QC workflow orchestration may include coordinating fluid sample reorder requests and coordinating capacity planning from real-time cell processing system data.

In some variations, QC workflow management may include linking fluid sample preparation methods with particular analytical measurements, enabling parallelization of methods on a same automated QC system, and managing fluid sample retesting.

In some variations, the grouping information may be defined by a rules engine that validates and coordinates business logic by defining multiple rules to coordinate individual or batch quality control requests, sets the priority of quality control requests, and coordinates quality control testing location (e.g., onsite, offsite).

In some variations, the LIMS may store fluid sample data, reagent data, and assay results data, create and manage assay result analysis and reports, track and link fluid devices to master well plates and sample well plates, and track QC system analytical instrument calibrations and quality control testing.

In some variations, the QC system automation control integrates analytical instruments with robotic plate handling to automate all assay method and results generation.

FIG. 9B provides the data management architecture to enable the collection, storage, and reporting of all assay and process data. Specifically, as shown in FIG. 9B, the LIMS of FIG. 9A may be a centralized QC data management center. The collection and management of fluid sample assay results provide a centralized environment for seamless data analysis and reporting. This capability enables rapid turn-around time on assay results to provide data feedback for in-process testing or cell therapy product release criteria.

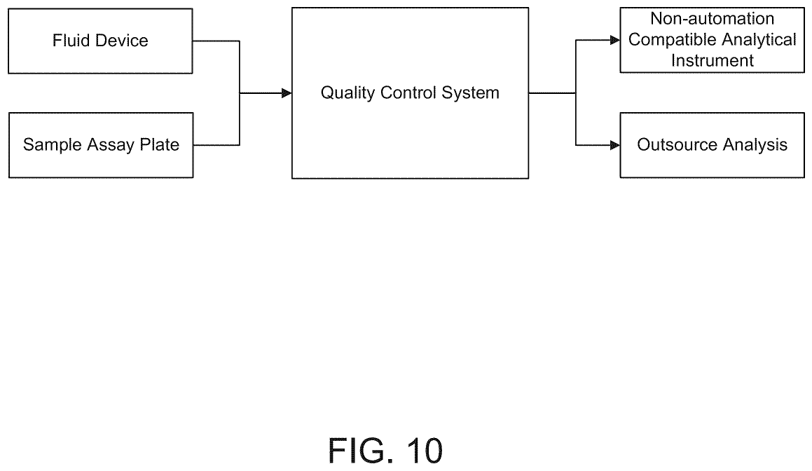

As referenced above, testing location may be used as a grouping information during QC orchestration. To this end, FIG. 10 is a flow diagram of a testing process for fluid samples destined for offsite evaluation. Offsite evaluation may be appropriate for fluid samples and/or analyses that cannot be performed within the QC system or are not automation compatible. For example, an offline assay may include a DNA sequencing assay, or another type of specialty assay, that may not be commonly used during cell therapy testing. These offline assays require additional lab employees to prepare, operate, and manage fluid samples and data analysis. The process is also time-consuming and error-prone, which may lead to delays with in-process or lot-release quality control results. As shown in FIG. 10, the QC system enables the processing of samples to run with offline workflows with non-automation-capable instruments or outsourced analysis. This offline workflow integration still allows for centralized sample data and report collection and enables the sterile transfer of fluid samples from a fluid device to any offline sample container format. For example, a fluid device destined for offsite evaluation may still be considered during QC orchestration. When appropriate, the fluid device may be delivered to a fluid device docking station of the QC system, along with a sample assay plate or other suitable container. The fluid transfer system of the QC system may prepare the sample assay plate with the fluid sample of the fluid device and then the prepared sample assay plate may be removed from the QC system and delivered offsite for non-automation compatible analysis and or otherwise outsourced analysis. The advantage is that the QC system still serves as a tool and/or a datahub, thereby allowing for centralized sample data and report collection regardless of testing location.

### C. EXAMPLES

### Example 1

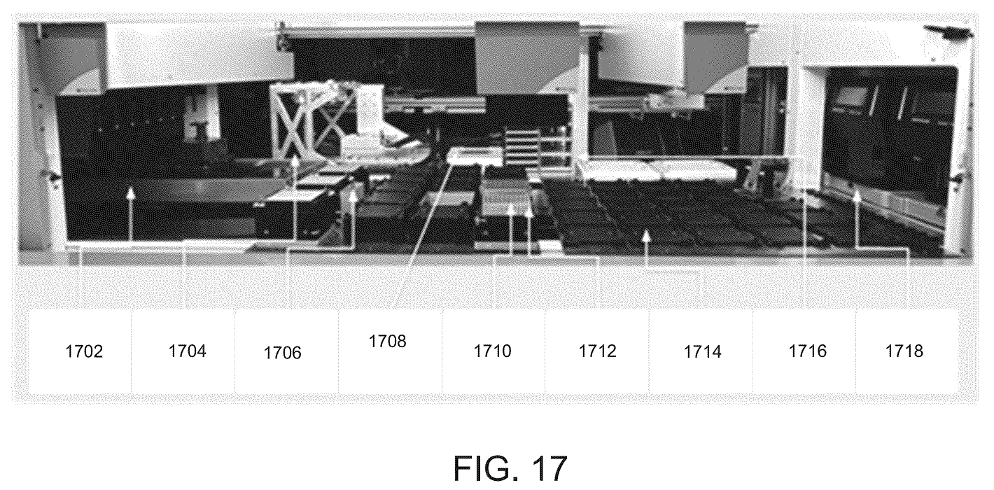

FIG. 17 shows an arrangement of analytical and operational instruments and tools within an interior zone 1720 of exemplary quality control (QC) system 1700. The QC processing occurs substantially from left to right as pictured, with device preparation and tracking instrumentation and tools positioned toward the left of the interior zone 1720, sample and reagent preparation instrumentation and tools positioned toward the right of the interior zone 1720, and fluid transfer devices positioned centrally within the interior zone 1720. Accordingly, the QC system 1700 is fully integrated. In particular, an exemplary path of a sample (e.g., from fluid device 1730) through the QC system 1700 may be the following. First, the fluid device 1730 will enter the interior zone 1720 via the conveyor 1702 of the device transfer system. Next, the fluid device 1730 will be transferred to the fluid device disassembly instrument 1704 to access the fluid sample within the fluid device 1730. Next, if the fluid sample requires management, it will be transferred to the temperature-controlled plate agitator 1706. A barcode scanner 1708 is located centrally within the interior zone 1720 to read data associated with the fluid sample as it is transferred within the QC system 1700. Also centrally-located are the sample preparation and DNA isolation sections 1710, 1712, where the fluid sample will undergo necessary preparation for analysis. After sample preparation, the fluid sample will be disposed on an assay plate in the assay plate preparation section 1714. Following assay preparation with the sample, the assay plate will be thawed in the plate thawing station 1716. Finally, just prior to sample analysis, along a right side of the interior volume 1702, a tube containing the fluid sample may be opened using one of the tube decapping stations 1718.

### Example 2

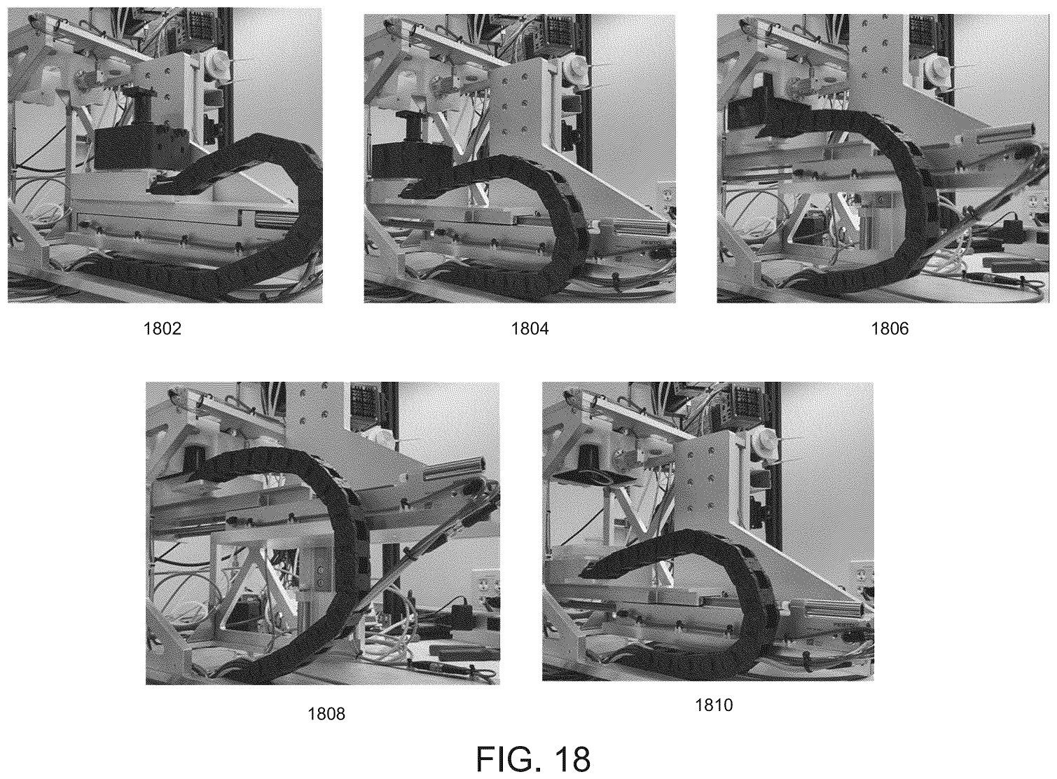

FIG. 18 shows a process of disassembling a fluid device using an exemplary fluid device disassembly instrument. At step 1802, the fluid device is secured to the transfer stag of the fluid device disassembly instrument via locking pins coupled to an underside of the container of the fluid device. At step 1804, the horizontal linear actuator coupled to the transfer stage transfers the stage and fluid device coupled thereto horizontally, proximal to (e.g., underneath) the disassembly actuator of the fluid device disassembly instrument. At step 1806, the vertical linear actuator coupled to the transfer stage transfers the stage and fluid device coupled thereto vertically, proximal to (e.g., within) the disassembly actuator. At step 1808, the disassembly actuator applies force to the collar of the fluid device, to counter the interlocking mechanism between the collar and the container of the fluid device (the collar surrounds the container and has engagement features that engage with complementary engagement features on the container. Finally, at step 1810 the vertical linear actuator coupled to the transfer stage transfers the stage and portion of the fluid device coupled thereto, the container, vertically, distal to (e.g., underneath) the disassembly actuator.

All references cited are herein incorporated by reference in their entirety.

Throughout this application, the term “about” is used to indicate that a value includes the inherent variation of error for the device or the method being employed to determine the value, or the variation that exists among the samples being measured. Unless otherwise stated or otherwise evident from the context, the term “about” means within 10% above or below the reported numerical value (except where such number would exceed 100% of a possible value or go below 0%). When used in conjunction with a range or series of values, the term “about” applies to the endpoints of the range or each of the values enumerated in the series, unless otherwise indicated. As used in this application, the terms “about” and “approximately” are used as equivalents.

While embodiments of the present invention have been shown and described herein, those skilled in the art will understand that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

1. A system for automated analysis of fluid samples from a cell processing system, the system comprising:
a fluid device docking station configured to receive a fluid device having a fluid sample therein;
a master well plate;
a sample well plate;
a fluid transfer system configured to
transfer the fluid sample from the fluid device to the master well plate, and
transfer at least a portion of the fluid sample from the master well plate to the sample well plate;
an analytical instrument configured to perform an assay on the fluid sample within the sample well plate; and
a robot configured to move the sample well plate to the analytical instrument.

2. The system of claim 1, further comprising a plurality of fluid device docking stations, each docking station configured to receive a fluid device therein.

3. The system of claim 1, wherein the fluid device comprises a barcode identifying the fluid sample therein.

4. The system of claim 1, further comprising a plurality of sample well plates, wherein a distribution of fluid within each of the plurality of sample well plates matches a distribution of fluid within the master well plate.

5. The system of claim 1, wherein the system is enclosed within a sterile environment.

6. The system of claim 1, wherein the analytical instrument is selected from the group consisting of a flow cytometer, a cell counter, a quantitative thermocycler, a fluorimeter, a flow-based bead reader, digital polymerase chain reaction, cell analyzers, and a microplate reader.

7. The system of claim 2, wherein each fluid device contains a different fluid.

8. The system of claim 7, wherein each fluid is selected from the group consisting of assay controls, assay reagents, and fluid samples.

9. The system of claim 8, wherein the assay reagents include buffers, dyes, antibodies, purified proteins, small molecules, or combinations thereof.

10. The system of claim 8, wherein the fluid samples are cell therapy products generated by the cell processing system.

11. The system of claim 1, wherein the fluid device docking station comprises a barcode reader configured to read a barcode associated with the fluid device received therein.

12. The system of claim 1, wherein the fluid device docking station comprises a wash solution reservoir.

13. The system of claim 1, further comprising an intermediate sample well plate, wherein the fluid transfer device is configured to transfer fluid from the master well plate to the sample well plate via the intermediate sample well plate.

14. A method for automated analysis of fluid samples from a cell processing system, the method comprising:
receiving a fluid device within a fluid device docking station, the fluid device comprising a fluid sample therein;
transferring, by a first fluid transfer device, the fluid sample from the fluid device to a master well plate;
transferring, by a second fluid transfer device, at least a portion of the fluid sample from the master well plate to a sample well plate; and
moving, by a robot, the sample well plate to an analytical instrument.

15. A method for automated analysis of fluid samples, comprising:
generating an assay order based on a number of fluid devices to be analyzed, each of the fluid devices containing a fluid sample corresponding to a cell therapy product within a cell processing system;
updating, based on a user input, grouping information for each of the fluid devices within the assay order, the grouping information including a priority indicator for the fluid devices and for an assay;
orchestrating a workflow of a quality control (QC) system based on the updated assay order and a cell processing workflow of the cell therapy product, the fluid devices initially being within the cell processing system;
receiving, based on the orchestration, a fluid device within a corresponding fluid device docking station of the QC system;
confirming an identity of the fluid device within the corresponding fluid device docking station;
transferring, based on the orchestration, fluid sample from the identified fluid device to a master well plate within the QC system;
transferring, based on the orchestration, fluid from the master well plate to at least one sample well plate within the QC system;
moving the at least one sample well plate to a corresponding analytical instrument within the QC system to perform an assay on the fluid sample therein;
determining, based on an assay output, whether the fluid sample satisfies one or more acceptance criterion for the assay; and
releasing the cell therapy product when it is determined that the fluid sample satisfies the one or more acceptance criterion.

16. The method of claim 15, further comprising
re-orchestrating the cell processing workflow of the cell therapy product when it is determined that the fluid sample does not satisfy the one or more acceptance criterion.

17. The method of claim 16, further comprising
re-generating the assay order, and
associating the re-generated assay order with the fluid sample.

18. The method of claim 15, wherein the grouping information includes number of fluid samples, sample testing location, and sample rework planning.

19. The method of claim 15, wherein the generated assay order includes an assay type to be performed for a fluid sample within each of the fluid devices.

20. The method of claim 15, wherein the orchestrating includes scheduling of cell processes related to the fluid devices.

21. The method of claim 15, wherein the orchestrating includes defining one or more acceptance criterion for each fluid sample.

22. The method of claim 15, wherein the orchestrating includes mapping the fluid samples to wells of each of the master well plate and the at least one sample well plate.

23. The method of claim 15, wherein the orchestrating includes managing assay reagents and assay controls.

24. The method of claim 15, wherein the orchestrating includes scheduling an assay start time for each assay within the assay order.

25. The method of claim 15, wherein the fluid devices are received in a particular order and with a particular timing based on the orchestration.

26. A method for automated analysis of fluid samples, comprising:
generating an assay order based on:
a number of fluid devices to be analyzed, each of the fluid devices containing a fluid sample; and
grouping information for each of the fluid devices, the grouping information including a priority indicator for each of the fluid devices;
orchestrating a workflow of a quality control (QC) system based on the generated assay order and a cell processing workflow of the fluid devices within a cell processing system;
receiving, based on the orchestration, a fluid device from the cell processing system and within a corresponding fluid device docking station of the QC system;
transferring, based on the orchestration, fluid sample from the fluid device to a master well plate within the QC system;
transferring, based on the orchestration, at least a portion of the fluid sample from the master well plate to a sample well plate within the QC system;
moving the sample well plate to a corresponding analytical instrument within the QC system to perform an assay on the fluid sample therein;
determining, based on an output of the assay, whether the fluid sample satisfies one or more acceptance criterion; and
releasing a fluid associated with the fluid sample when it is determined that the fluid sample satisfies the one or more acceptance criterion.

27-55. (canceled)
